(19) United States
(12) Patent Application Publication
(10) Pub. No.: US 2026/0038818 A1
(43) Pub. Date: Feb. 5, 2026

(54) SECONDARY BATTERY AND BATTERY PACK

(71) Applicant: MURATA MANUFACTURING CO., LTD., Kyoto (JP)

(72) Inventors: Mao ICHISHIMA, Kyoto (JP); Toshikazu NAKAMURA, Kyoto (JP); Kentaro OKAMOTO, Kyoto (JP)

(21) Appl. No.: 19/288,655

(22) Filed: Aug. 1, 2025

(30) Foreign Application Priority Data
Aug. 5, 2024 (JP) 2024-129129

(51) Int. Cl. H01M 4/36; H01M 4/02; H01M 10/0525; H01M 10/0587; H01M 50/107

(52) U.S. Cl. CPC H01M 4/366; H01M 10/0525; H01M 10/0587; H01M 50/107; H01M 2004/028

(57) ABSTRACT

A secondary battery includes an electrode wound body including a stacked body and having a through hole. The stacked body includes a positive electrode, a negative electrode, and a separator and is wound along a longitudinal direction of the stacked body. The positive electrode includes a positive electrode current collector, and a positive electrode active material layer stacked thereon. The positive electrode active material layer includes a thin part and a thick part. The thick part has a thickness greater than a thickness of the thin part and is positioned on a winding outer periphery side of the electrode wound body relative to the thin part in the longitudinal direction. A position of a border between the thin part and the thick part is different, in a radial direction of the electrode wound body, from a position overlapping a position of a winding center side edge of the positive electrode.

### CROSS-REFERENCE TO RELATED APPLICATIONS

The present application claims priority from Japanese Patent Application No. 2024-129129 filed on Aug. 5, 2024, the entire contents of which are hereby incorporated by reference.

### BACKGROUND

The present disclosure relates to a secondary battery, and to a battery pack including the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member. A configuration of the secondary battery has been considered in various ways.

For example, a secondary battery is proposed in which what is called a tabless structure is employed. Such a secondary battery achieves a reduced internal resistance and allows for charging and discharging with a relatively large current.

### SUMMARY

A secondary battery according to an embodiment of the present disclosure includes an electrode wound body, and an outer package can containing the electrode wound body. The electrode wound body includes a stacked body and has a through hole. The stacked body includes a positive electrode, a negative electrode, and a separator and is wound along a longitudinal direction of the stacked body. The through hole extends through the electrode wound body in a width direction intersecting the longitudinal direction.

The positive electrode includes a positive electrode current collector, and a positive electrode active material layer stacked on the positive electrode current collector and including a positive electrode active material. The positive electrode active material layer includes a thin part and a thick part. The thick part has a thickness greater than a thickness of the thin part and is positioned on a winding outer periphery side of the electrode wound body relative to the thin part in the longitudinal direction. A position of a border between the thin part and the thick part is different, in a radial direction of the electrode wound body, from a position overlapping a position of a winding center side edge of the positive electrode. The winding center side edge is an edge of the positive electrode on a winding center side of the electrode wound body in the longitudinal direction.

A battery pack according to an embodiment of the present disclosure includes a secondary battery, a processor, and an outer package body. The processor is configured to control the secondary battery. The outer package body contains the secondary battery.

The secondary battery includes an electrode wound body, and an outer package can containing the electrode wound body. The electrode wound body includes a stacked body and has a through hole. The stacked body includes a positive electrode, a negative electrode, and a separator and is wound along a longitudinal direction of the stacked body. The through hole extends through the electrode wound body in a width direction intersecting the longitudinal direction. The positive electrode includes a positive electrode current collector, and a positive electrode active material layer stacked on the positive electrode current collector and including a positive electrode active material. The positive electrode active material layer includes a thin part and a thick part. The thick part has a thickness greater than a thickness of the thin part and is positioned on a winding outer periphery side of the electrode wound body relative to the thin part in the longitudinal direction. A position of a border between the thin part and the thick part is different, in a radial direction of the electrode wound body, from a position overlapping a position of a winding center side edge of the positive electrode. The winding center side edge is an edge of the positive electrode on a winding center side of the electrode wound body in the longitudinal direction.

### BRIEF DESCRIPTION OF THE FIGURES

The accompanying drawings are included to provide a further understanding of the present disclosure and are incorporated in and constitute a part of this specification. The drawings illustrate example embodiments and, together with the specification, serve to explain the principles of the present disclosure.

FIG. 1 is a sectional diagram illustrating a configuration example of a vertical sectional structure, along a height direction, of a secondary battery according to one example embodiment of the present disclosure.

FIG. 2 is a schematic diagram illustrating a configuration example of a stacked body including a positive electrode, a negative electrode, and a separator illustrated in FIG. 1.

FIG. 3 is a sectional diagram illustrating a first configuration example of a horizontal sectional structure of an electrode wound body illustrated in FIG. 1.

FIG. 4A is a developed diagram illustrating a configuration example of the positive electrode illustrated in FIG. 1.

FIG. 4B is a first sectional diagram illustrating a configuration example of the positive electrode illustrated in FIG. 1.

FIG. 4C is a second sectional diagram illustrating a configuration example of the positive electrode illustrated in FIG. 1.

FIG. 5 is a sectional diagram illustrating a second configuration example of a horizontal sectional structure of the electrode wound body illustrated in FIG. 1.

FIG. 6 is a sectional diagram illustrating a configuration example of the positive electrode included in the electrode wound body illustrated in FIG. 5.

FIG. 7A is a developed diagram illustrating a configuration example of the negative electrode illustrated in FIG. 1.

FIG. 7B is a sectional diagram illustrating a configuration example of the negative electrode illustrated in FIG. 1.

FIG. 8A is a plan diagram illustrating a configuration example of a positive electrode current collector plate illustrated in FIG. 1.

FIG. 8B is a plan diagram illustrating a configuration example of a negative electrode current collector plate illustrated in FIG. 1.

FIGS. 9A to 9F are each a perspective diagram describing a process of manufacturing the secondary battery illustrated in FIG. 1.

FIG. 10 is a block diagram illustrating a circuit configuration of a battery pack to which the secondary battery according to one example embodiment of the present disclosure is applied.

FIG. 11A is a sectional diagram illustrating a first example of a positive electrode according to a first modification example of one example embodiment of the present disclosure.

FIG. 11B is a sectional diagram illustrating a second example of the positive electrode according to the first modification example of one example embodiment of the present disclosure.

FIG. 11C is a sectional diagram illustrating a third example of the positive electrode according to the first modification example of one example embodiment of the present disclosure.

FIG. 12A is a developed diagram illustrating a configuration example of a positive electrode according to a second modification example of one example embodiment of the present disclosure.

FIG. 12B is a sectional diagram illustrating a configuration example of the positive electrode illustrated in FIG. 12A.

FIG. 13A is a developed diagram illustrating a configuration example of a positive electrode according to a third modification example of one example embodiment of the present disclosure.

FIG. 13B is a sectional diagram illustrating a configuration example of the positive electrode illustrated in FIG. 13A.

FIG. 14 is a developed diagram illustrating a configuration example of a positive electrode according to a fourth modification example of one example embodiment of the present disclosure.

FIG. 15 is a sectional diagram illustrating a configuration example of a vertical sectional structure, along a height direction, of a secondary battery according to a fifth modification example of one example embodiment of the present disclosure.

FIG. 16A is a developed diagram illustrating a configuration example of a positive electrode mounted on the secondary battery illustrated in FIG. 15.

FIG. 16B is a developed diagram illustrating a configuration example of a negative electrode mounted on the secondary battery illustrated in FIG. 15.

FIG. 17A is a first sectional view of the positive electrode illustrated in FIG. 16A.

FIG. 17B is a second sectional view of the positive electrode illustrated in FIG. 16A.

### DETAILED DESCRIPTION

Consideration has been given in various ways to improve performance of a secondary battery. However, there is still room for improvement in reliability of the secondary battery.

It is desirable to provide a secondary battery that is superior in reliability, and a battery pack that includes such a secondary battery.

The present disclosure is described below in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

First, a description is given of a secondary battery according to an example embodiment of the present disclosure.

In the present example embodiment, a cylindrical lithium-ion secondary battery having an outer appearance of a cylindrical shape will be described as an example. However, a secondary battery of an embodiment of the present disclosure is not limited to the cylindrical lithium-ion secondary battery, and may be a lithium-ion secondary battery having an outer appearance of a shape other than the cylindrical shape, or may be a secondary battery in which an electrode reactant other than lithium is used.

Although a charge and discharge principle of the secondary battery is not particularly limited, the following description deals with a case where a battery capacity is obtained through insertion and extraction of the electrode reactant. The secondary battery may include a positive electrode, a negative electrode, and an electrolyte. In the secondary battery, to prevent precipitation of the electrode reactant on a surface of the negative electrode during charging, a charge capacity of the negative electrode may be greater than a discharge capacity of the positive electrode. For example, an electrochemical capacity per unit area of the negative electrode may be set to be greater than an electrochemical capacity per unit area of the positive electrode.

The electrode reactant is not particularly limited in kind, as described above. For example, the electrode reactant may be a light metal such as an alkali metal or an alkaline earth metal. Non-limiting examples of the alkali metal may include lithium, sodium, and potassium. Non-limiting examples of the alkaline earth metal may include beryllium, magnesium, and calcium.

In the following, described as an example is a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

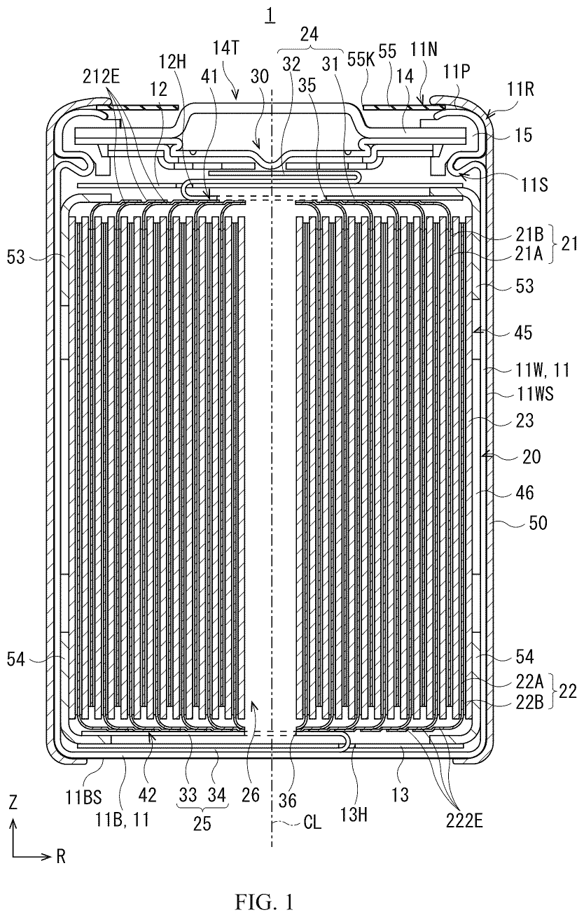

FIG. 1 illustrates a vertical sectional configuration, along a height direction, of a lithium-ion secondary battery 1 according to the present example embodiment. The lithium-ion secondary battery 1 according to the present example embodiment may be hereinafter simply referred to as the “secondary battery 1”. The secondary battery 1 illustrated in FIG. 1 may include an outer package can 11 and an electrode wound body 20. The outer package can 11 may have a substantially cylindrical shape. The electrode wound body 20 may be contained in the outer package can 11 and may serve as a battery device. The secondary battery 1 may further include an outer package tube 50. The outer package tube 50 may cover an outer peripheral surface of the outer package can 11. Note that, herein, the height direction of the secondary battery 1 corresponds to a Z-axis direction.

For example, the secondary battery 1 may include, inside the outer package can 11, a pair of insulating plates 12 and 13, the electrode wound body 20, a positive electrode current collector plate 24, and a negative electrode current collector plate 25. The electrode wound body 20 may be a structure in which a positive electrode 21 and a negative electrode 22 are stacked on each other with a separator 23 interposed therebetween and are wound, for example. The electrode wound body 20 may be impregnated with an electrolytic solution. The electrolytic solution may be a liquid electrolyte. In some embodiments, the secondary battery 1 may further include a thermosensitive resistive device, a reinforcing member, or both inside the outer package can 11. Non-limiting examples of the thermosensitive resistive device may include a positive temperature coefficient (PTC) device.

The outer package can 11 may contain components including, without limitation, the positive electrode current collector plate 24, the negative electrode current collector plate 25, and the electrode wound body 20. The outer package can 11 may include a bottom part 11B and a sidewall part 11W. The bottom part 11B may also serve as a negative electrode terminal coupled to the negative electrode 22 via the negative electrode current collector plate 25. The outer package can 11 may have, for example, a hollow cylindrical structure having a lower end part and an upper end part in the Z-axis direction. The lower end part may be closed, and the upper end part may be open. The upper end part of the outer package can 11 may thus be an open end part 11N. The lower end part of the outer package can 11 may be closed by the bottom part 11B having a substantially circular plate shape. The sidewall part 11W may be provided between the open end part 11N and the bottom part 11B and may surround the electrode wound body 20. The sidewall part 11W may so stand in the height direction and along an outer edge of the bottom part 11B as to surround the electrode wound body 20. The sidewall part 11W may include the open end part 11N on an opposite side to the bottom part 11B. The open end part 11N may be open to allow the electrode wound body 20 to be passed therethrough. The outer package can 11 may include, for example, a metal material such as iron. In some embodiments, a surface of the outer package can 11 may be plated with a metal material such as nickel. The insulating plate 12 and the insulating plate 13 may be so opposed to each other as to allow the electrode wound body 20 to be interposed therebetween in the Z-axis direction, for example. Note that, herein, the open end part 11N and the vicinity thereof may be referred to as an upper part of the secondary battery 1 in the Z-axis direction, and a region where the outer package can 11 is closed and the vicinity thereof may be referred to as a lower part of the secondary battery 1 in the Z-axis direction.

The outer package tube 50 may surround a side surface 11WS that is an outer surface of the sidewall part 11W of the outer package can 11. In some embodiments, the outer package tube 50 may cover a bent part 11P positioned at the upper end part of the outer package can 11, as illustrated in FIG. 1. The bent part 11P will be described later. In some embodiments, the outer package tube 50 may cover a part of a bottom surface 11BS that is an outer surface of the bottom part 11B of the outer package can 11. The outer package tube 50 may include, for example, a thermally contractible insulating film that includes a material such as a polyester-based resin, a polyamide-based resin, or a thermoplastic elastomer resin.

A washer 55 may be provided in a gap between the outer package tube 50 and the bent part 11P of the outer package can 11. The washer 55 may be an insulating ring member that has an opening 55K in a middle region in a plane orthogonal to the height direction. Disposed in the opening 55K may be a projecting part 14T provided in a middle region of a battery cover 14. The washer 55 may include a material such as black modified polyphenylene ether.

Each of the insulating plates 12 and 13 may be, for example, a dish-shaped plate having a surface perpendicular to a central axis CL of the electrode wound body 20, that is, a surface perpendicular to a Z-axis in FIG. 1. The insulating plates 12 and 13 may be so disposed as to allow the electrode wound body 20 to be interposed therebetween.

For example, at the open end part 11N of the outer package can 11, a structure in which the battery cover 14 and a safety valve mechanism 30 are crimped with a gasket 15 interposed between the open end part 11N and both the battery cover 14 and the safety valve mechanism 30 may be provided. The structure may be referred to as a crimped structure 11R. The outer package can 11 may be sealed by the battery cover 14, with the electrode wound body 20 and other components being contained inside the outer package can 11. The crimped structure 11R may include the bent part 11P serving as what is called a crimp part. A narrow part 11S may be provided between the bent part 11P and the insulating plate 12. The narrow part 11S may be a part of the outer package can 11 that protrudes inward.

The battery cover 14 may be a closing member that closes the open end part 11N in a state where the electrode wound body 20 and other components are contained inside the outer package can 11, for example. The battery cover 14 may be, for example, an electrical conductor that includes a material similar to the material included in the outer package can 11. The battery cover 14 may close the open end part 11N of the outer package can 11 and may be coupled to the positive electrode current collector plate 24. Therefore, the battery cover 14 may also serve as a positive electrode terminal coupled to the positive electrode 21 via the positive electrode current collector plate 24. The middle region of the battery cover 14 may protrude upward, i.e., in a +Z direction, for example. Accordingly, a peripheral region, i.e., a region other than the middle region, of the battery cover 14 may be in contact with the safety valve mechanism 30, for example.

The gasket 15 may be a sealing member interposed between the bent part 11P of the outer package can 11 and the battery cover 14, for example. The gasket 15 may seal a gap between the bent part 11P and the battery cover 14. In some embodiments, a surface of the gasket 15 may be coated with a material such as asphalt. The gasket 15 may include any one or more of insulating materials, for example. The insulating material is not particularly limited in kind, and non-limiting examples thereof may include a polymer material such as polybutylene terephthalate (PBT) or polypropylene (PP). In some embodiments, the insulating material may be polybutylene terephthalate. One reason for this is that this helps to allow for sufficient sealing of the gap between the bent part 11P and the battery cover 14, with the outer package can 11 and the battery cover 14 being electrically separated from each other.

The safety valve mechanism 30 may be adapted to cancel the sealed state of the outer package can 11 to thereby release a pressure inside the outer package can 11, i.e., an internal pressure of the outer package can 11, on an as-needed basis upon an increase in the internal pressure of the outer package can 11, for example. Non-limiting examples of a cause of the increase in the internal pressure of the outer package can 11 may include a gas generated due to a decomposition reaction of the electrolytic solution upon charging and discharging. The internal pressure of the outer package can 11 can also increase due to heating from outside.

The electrode wound body 20 may be disposed between the positive electrode current collector plate 24 and the negative electrode current collector plate 25. The electrode wound body 20 may have an upper end face 41 and a lower end face 42. The upper end face 41 may face the positive electrode current collector plate 24 in the height direction. The lower end face 42 may face the negative electrode current collector plate 25 in the height direction. The electrode wound body 20 may be a power generation device that causes charging and discharging reactions to proceed, and may be contained inside the outer package can 11. The electrode wound body 20 may include the positive electrode 21, the negative electrode 22, the separator 23, and the electrolytic solution, i.e., a liquid electrolyte.

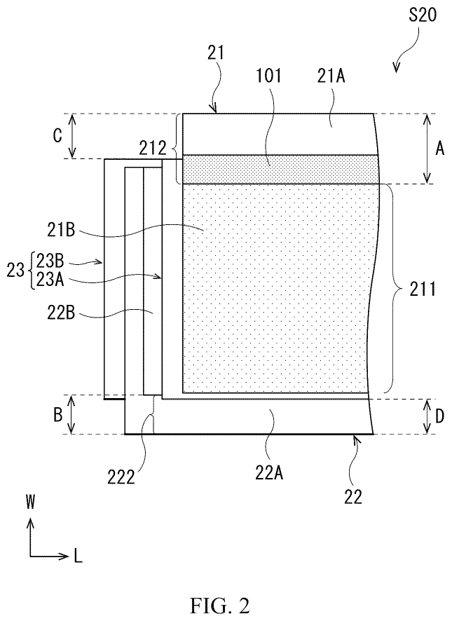

FIG. 2 is a developed view of the electrode wound body 20. For example, FIG. 2 schematically illustrates a part of a stacked body S20 corresponding to the electrode wound body 20 in an unwound state. The stacked body S20 includes the positive electrode 21, the negative electrode 22, and the separator 23. In the stacked body S20, the positive electrode 21 and the negative electrode 22 may be stacked on each other with the separator 23 interposed therebetween. The separator 23 may include, for example, two bases, i.e., a first separator member 23A and a second separator member 23B. The electrode wound body 20 may thus include the stacked body S20 that is four-layered. In the four-layered stacked body S20, the positive electrode 21, the first separator member 23A, the negative electrode 22, and the second separator member 23B may be stacked in order. Each of the positive electrode 21, the first separator member 23A, the negative electrode 22, and the second separator member 23B may be a substantially band-shaped member in which a W direction corresponds to a transverse direction and an L direction corresponds to a longitudinal direction.

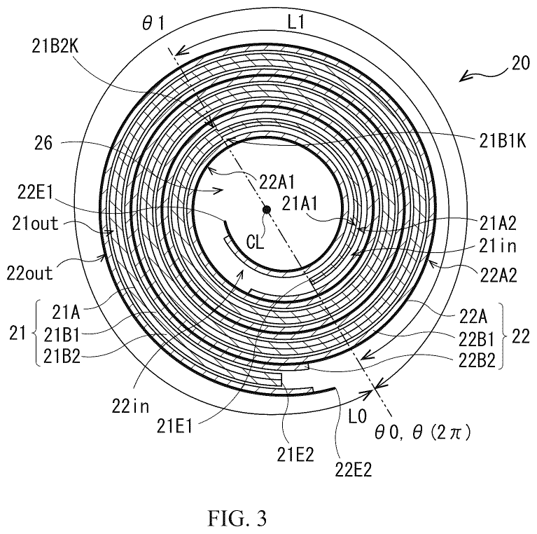

As illustrated in FIG. 3, the electrode wound body 20 may be the stacked body S20 so wound around a through hole 26 that extends along the central axis CL extending in the Z-axis direction as to form a spiral shape in a horizontal section orthogonal to the Z-axis direction. The stacked body S20 may be wound along the L direction corresponding to the longitudinal direction, in an orientation in which the W direction corresponding to the transverse direction substantially coincides with the Z-axis direction. Note that FIG. 3 illustrates a first configuration example of the electrode wound body 20, along the horizontal section orthogonal to the Z-axis direction. Note that, for higher visibility, FIG. 3 omits illustration of the separator 23. The electrode wound body 20 may have an outer appearance of a substantially circular columnar shape as a whole. The positive electrode 21 and the negative electrode 22 may be wound, remaining in a state of being opposed to each other with the separator 23 interposed therebetween. The electrode wound body 20 may have the through hole 26 as an internal space at a center thereof. The through hole 26 may be a hole into which a winding core for assembling the electrode wound body 20 and an electrode rod for welding are each to be put. The through hole 26 may extend in the Z-axis direction along the central axis CL, and may be provided through the electrode wound body 20. The stacked body S20 may thus be wound around the through hole 26.

The positive electrode 21, the negative electrode 22, and the separator 23 may be so wound that the separator 23 is positioned in each of an outermost wind of the electrode wound body 20 and an innermost wind of the electrode wound body 20. In the outermost wind of the electrode wound body 20, the negative electrode 22 may be positioned on an outer side relative to the positive electrode 21. For example, as illustrated in FIG. 3, an outermost positive electrode wind part 21out positioned in an outermost wind of the positive electrode 21 included in the electrode wound body 20 may be positioned on an inner side relative to an outermost negative electrode wind part 22out positioned in an outermost wind of the negative electrode 22 included in the electrode wound body 20. Here, the outermost positive electrode wind part 21out may be a part corresponding to the outermost one wind of the positive electrode 21 in the electrode wound body 20. The outermost negative electrode wind part 22out may be a part corresponding to the outermost one wind of the negative electrode 22 in the electrode wound body 20. In contrast, in the innermost wind of the electrode wound body 20, the negative electrode 22 may be positioned on the inner side relative to the positive electrode 21. For example, as illustrated in FIG. 3, an innermost negative electrode wind part 22 in positioned in an innermost wind of the negative electrode 22 included in the electrode wound body 20 may be positioned on the inner side relative to an innermost positive electrode wind part 21 in positioned in an innermost wind of the positive electrode 21 included in the electrode wound body 20. Here, the innermost positive electrode wind part 21 in may be a part corresponding to the innermost one wind of the positive electrode 21 in the electrode wound body 20. The innermost negative electrode wind part 22 in may be a part corresponding to the innermost one wind of the negative electrode 22 in the electrode wound body 20. The number of winds of each of the positive electrode 21, the negative electrode 22, and the separator 23 is not particularly limited, and may be chosen as desired.

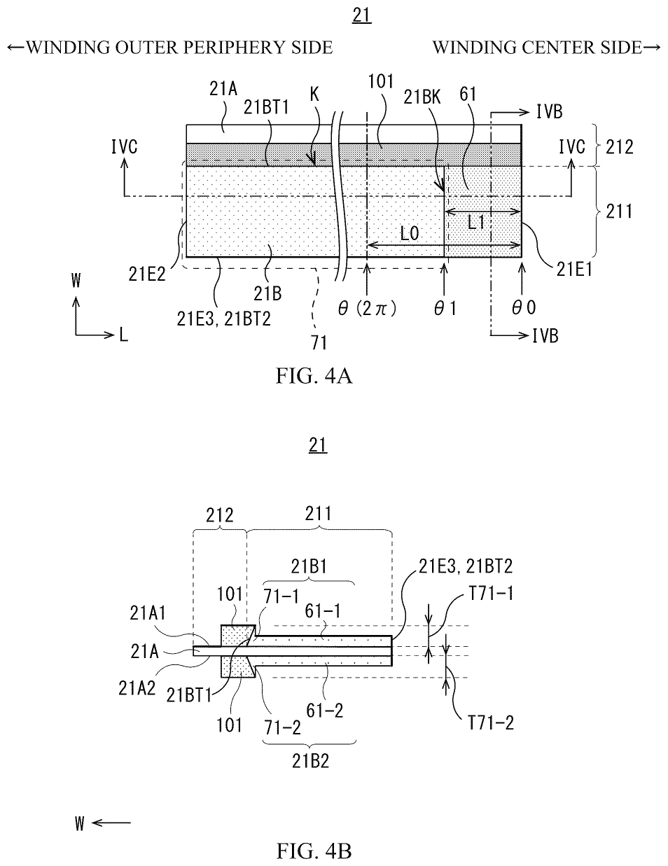

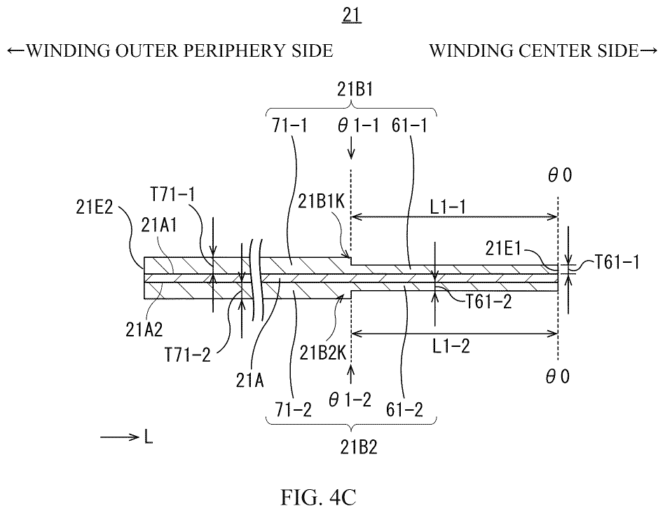

FIG. 4A is a developed view of the positive electrode 21, and schematically illustrates a state before being wound. FIGS. 4B and 4C each illustrate a sectional configuration of the positive electrode 21. Note that FIG. 4B illustrates a section as viewed in an arrowed direction along line IVB-IVB illustrated in FIG. 4A. FIG. 4C illustrates a section as viewed in an arrowed direction along line IVC-IVC illustrated in FIG. 4A. The positive electrode 21 includes, for example, a positive electrode current collector 21A and a positive electrode active material layer 21B. The positive electrode active material layer 21B may cover a part of the positive electrode current collector 21A. In some embodiments, the positive electrode active material layer 21B may be provided, for example, simply on one of two opposite surfaces of the positive electrode current collector 21A. In some embodiments, the positive electrode active material layer 21B may be provided, for example, on each of the two opposite surfaces of the positive electrode current collector 21A. In some embodiments, the positive electrode active material layer 21B may have a single-layered structure that includes a single film including the positive electrode active material. In some embodiments, the positive electrode active material layer 21B may have a multi-layered structure including multiple layers that are stacked and each include the positive electrode active material. FIGS. 3, 4B, and 4C each illustrate a case where the positive electrode active material layer 21B is provided on each of the two opposite surfaces of the positive electrode current collector 21A. In some embodiments, the positive electrode current collector 21A may include an inward positive electrode current collector surface 21A1 and an outward positive electrode current collector surface 21A2. The inward positive electrode current collector surface 21A1 may face toward a winding center side of the electrode wound body 20, i.e., toward the central axis CL. The outward positive electrode current collector surface 21A2 may face toward an opposite side to the winding center side of the electrode wound body 20. In other words, the outward positive electrode current collector surface 21A2 may be positioned on an opposite side of the positive electrode current collector 21A to the inward positive electrode current collector surface 21A1. In some embodiments, the positive electrode 21 may include an inner winding side positive electrode active material layer 21B1 and an outer winding side positive electrode active material layer 21B2, as the positive electrode active material layers 21B. The inner winding side positive electrode active material layer 21B1 may cover all or a part of the inward positive electrode current collector surface 21A1. The outer winding side positive electrode active material layer 21B2 may cover all or a part of the outward positive electrode current collector surface 21A2. Herein, the inner winding side positive electrode active material layer 21B1 and the outer winding side positive electrode active material layer 21B2 may each be generically referred to as the positive electrode active material layer 21B, without being distinguished from each other. The inner winding side positive electrode active material layer 21B1 may correspond to a specific but non-limiting example of a “first positive electrode active material layer” in an embodiment of the present disclosure. The outer winding side positive electrode active material layer 21B2 may correspond to a specific but non-limiting example of a “second positive electrode active material layer” in an embodiment of the present disclosure.

In some embodiments, the positive electrode 21 may include a positive electrode covered region 211 and a positive electrode exposed region 212. In some embodiments, the positive electrode covered region 211 may be a region in which the positive electrode current collector 21A is covered with the positive electrode active material layer 21B. In some embodiments, the positive electrode exposed region 212 may be a region in which the positive electrode current collector 21A is exposed without being covered with the positive electrode active material layer 21B. The positive electrode exposed region 212 may extend in the W direction. As illustrated in FIG. 4A, the positive electrode covered region 211 and the positive electrode exposed region 212 may each extend along the L direction, i.e., a longitudinal direction of the positive electrode 21, from a winding center side edge 21E1 of the positive electrode 21, i.e., an edge of the positive electrode 21 on the winding center side in the L direction, to a winding outer periphery side edge 21E2 of the positive electrode 21, i.e., an edge of the positive electrode 21 on a winding outer periphery side in the L direction. Here, the L direction corresponds to a winding direction of the electrode wound body 20. For example, in the positive electrode 21, the positive electrode current collector 21A may be covered with the positive electrode active material layer 21B from the winding center side edge 21E1 of the positive electrode 21 to the winding outer periphery side edge 21E2 of the positive electrode 21 in the winding direction of the electrode wound body 20. The positive electrode covered region 211 and the positive electrode exposed region 212 may be adjacent to each other in the W direction, i.e., a transverse direction of the positive electrode 21. The W direction substantially coincides with the central axis CL. The positive electrode active material layer 21B may extend in both the L direction and the W direction orthogonal to the L direction. The L direction corresponds to the longitudinal direction of the positive electrode 21. The W direction corresponds to a width direction of the positive electrode 21. As illustrated in FIG. 3, in the electrode wound body 20, the winding center side edge 21E1 at the innermost positive electrode wind part 21 in may be located at a position retracted in the L direction from a winding center side edge 22E1 of the negative electrode 22, i.e., an edge of the negative electrode 22 on the winding center side in the L direction, at the innermost negative electrode wind part 22 in. The positive electrode 21 may further have a lower edge 21E3 that extends in the L direction on a lower side of the electrode wound body 20. Note that FIGS. 4A and 4B each schematically illustrate the positive electrode current collector 21A in a straightened state along the W direction. In actuality, however, as illustrated in FIG. 1, a positive electrode edge part 212E of the positive electrode exposed region 212 may be bent toward the central axis CL and may be coupled to the positive electrode current collector plate 24. For example, the positive electrode edge part 212E that is an end part of the positive electrode exposed region 212 in the W direction may form the upper end face 41 and may be coupled to the positive electrode current collector plate 24, as illustrated in FIG. 1. The upper end face 41 may be a part, of the positive electrode edge part 212E of the positive electrode exposed region 212, that is bent toward the through hole 26 in a state where the electrode wound body 20 is wound.

In some embodiments, an insulating layer 101 may be provided in a region including a border K between the positive electrode covered region 211 and the positive electrode exposed region 212 and the vicinity of the border K. In some embodiments, as with the positive electrode covered region 211 and the positive electrode exposed region 212, the insulating layer 101 may also extend from the winding center side edge 21E1 to the winding outer periphery side edge 21E2 in the electrode wound body 20. In some embodiments, the insulating layer 101 may be adhered to the first separator member 23A, the second separator member 23B, or both. One reason for this is that this helps to prevent the positive electrode 21 and the separator 23 from becoming misaligned with each other. In some embodiments, the insulating layer 101 may include a resin including polyvinylidene difluoride (PVDF). One reason for this is that when the insulating layer 101 includes PVDF, the insulating layer 101 is swollen by, for example, a solvent included in the electrolytic solution, which helps to allow the insulating layer 101 to be favorably adhered to the separator 23.

In the positive electrode 21 of the present example embodiment, a first end face 21BT1 of the positive electrode active material layer 21B may be an inclined surface, as illustrated in FIG. 4B. The insulating layer 101 may be in contact with the first end face 21BT1 positioned at the border K. For example, the insulating layer 101 may cover the first end face 21BT1 of the positive electrode active material layer 21B and the vicinity thereof. The positive electrode active material layer 21B includes a thin part 61 and a thick part 71. The thin part 61 may correspond to a specific but non-limiting example of a “thin part” in an embodiment of the present disclosure. The thick part 71 may correspond to a specific but non-limiting example of a “thick part” in an embodiment of the present disclosure. In some embodiments, the thin part 61 and the thick part 71 in the positive electrode 21 may both be provided on each of the inward positive electrode current collector surface 21A1 and the outward positive electrode current collector surface 21A2. In other words, each of the inner winding side positive electrode active material layer 21B1 and the outer winding side positive electrode active material layer 21B2 may include each of the thin part 61 and the thick part 71. In some embodiments, however, in the positive electrode 21, it may suffice that at least either the inner winding side positive electrode active material layer 21B1 or the outer winding side positive electrode active material layer 21B2 includes the thin part 61 and the thick part 71. Note that, for convenience, in FIGS. 4B and 4C, the thin part 61 and the thick part 71 included in the inner winding side positive electrode active material layer 21B1 are respectively denoted as a thin part 61-1 and a thick part 71-1. The thin part 61 and the thick part 71 included in the outer winding side positive electrode active material layer 21B2 are respectively denoted as a thin part 61-2 and a thick part 71-2. Further, in the example illustrated in FIGS. 3 and 4C, a position of a border 21BIK between the thin part 61-1 and the thick part 71-1 in the L direction may substantially coincide with a position of a border 21B2K between the thin part 61-2 and the thick part 71-2 in the L direction.

The thick part 71 has a thickness greater than a thickness of the thin part 61. For example, the thickness of the thin part 61 may be about half the thickness of the thick part 71. For example, as illustrated in each of FIGS. 4B and 4C, in the inner winding side positive electrode active material layer 21B1, a thickness T71-1 of the thick part 71-1 may be greater than a thickness T61-1 of the thin part 61-1. Similarly, in the outer winding side positive electrode active material layer 21B2, a thickness T71-2 of the thick part 71-2 may be greater than a thickness T61-2 of the thin part 61-2. In some embodiments, the thickness T61-1 and the thickness T61-2 may be equal to each other. In some embodiments, the thickness T61-1 and the thickness T61-2 may be different from each other. In some embodiments, the thickness T71-1 and the thickness T71-2 may be equal to each other. In some embodiments, the thickness T71-1 and the thickness T71-2 may be different from each other.

The thin part 61 may include the winding center side edge 21E1 of the positive electrode 21 in the L direction. In some embodiments, the thin part 61 may have a length in the L direction that corresponds to, for example, about one wind to about five winds of the electrode wound body 20 from the winding center side edge 21E1. In some embodiments, the thin part 61 may be present only in the innermost positive electrode wind part 21 in that corresponds to the innermost one wind of the positive electrode 21 included in the electrode wound body 20. In addition, as illustrated in FIG. 3, a position of the border 21BIK between the thin part 61 and the thick part 71 and a position of the border 21B2K between the thin part 61 and the thick part 71 may each be different from a position overlapping a position of the winding center side edge 21E1 of the positive electrode 21 in a radial direction of the electrode wound body 20. This will be described further below.

As illustrated in FIGS. 3 and 4A, in a horizontal plane orthogonal to the Z-axis direction, a position of a line segment starting from the central axis CL and passing through the winding center side edge 21E1 is denoted as θ0. Here, a length of the positive electrode 21 from the position θ0 to a position θ(2π) is denoted as L0. The position θ(2π) is a position one wind around the central axis CL from the position θ0. The length of the positive electrode 21 from the position θ0 to the position θ(2π) may be, in other words, a length of the innermost positive electrode wind part 21 in in the electrode wound body 20. A length of the positive electrode 21 from the position θ0 of the winding center side edge 21E1 of the positive electrode 21 to a position θ1 of a border 21BK between the thin part 61 and the thick part 71 is denoted as L1. A length of the positive electrode 21 from the position θ0 of the winding center side edge 21E1 of the positive electrode 21 to a position θ1-1 of the border 21BIK between the thin part 61-1 and the thick part 71-1 is denoted as L1-1, and a length of the positive electrode 21 from the position θ0 of the winding center side edge 21E1 of the positive electrode 21 to a position θ1-2 of the border 21B2K between the thin part 61-2 and the thick part 71-2 is denoted as L1-2. In the electrode wound body 20, a ratio L1/L0, i.e., a ratio of the length L1 to the length L0, may have a numerical value other than natural numbers. For example, where one full rotation from the position θ0 to the position θ(2π) around the central axis CL is regarded as one cycle, a phase of the position θ1 (e.g., each of the positions θ1-1 and θ1-2) may be different from a phase of the position θ0. In some embodiments, a phase difference between the position θ0 and the position θ1 may be ⅓ radians (≈19° or greater. In some embodiments, when the electrode wound body 20 is unwound on a flat plane as illustrated in FIG. 4A, a distance from the position θ0 to the position θ1 may be R/3 or greater, where R is a radius of curvature of the positive electrode 21 at the border 21BK or in the vicinity thereof. In some embodiments, the ratio L1/L0 may satisfy Expression (1) below. One reason for this is that this helps to easily avoid concentration of stress on, for example, a part, of the separator 23, abutting the winding center side edge 21E1, caused by swelling of the negative electrode 22 upon charging.

$$0.1 \leq L 1 / L 0 \leq 0.95 \qquad ( 1 )$$

In some embodiments, the ratio L1/L0 may satisfy Expression (2) below. One reason for this is that this helps to further reduce the concentration of the stress on, for example, the part, of the separator 23, abutting the winding center side edge 21E1, caused by the swelling of the negative electrode 22 upon charging.

$$0.25 \leq L 1 / L 0 \leq 0.75 \qquad ( 2 )$$

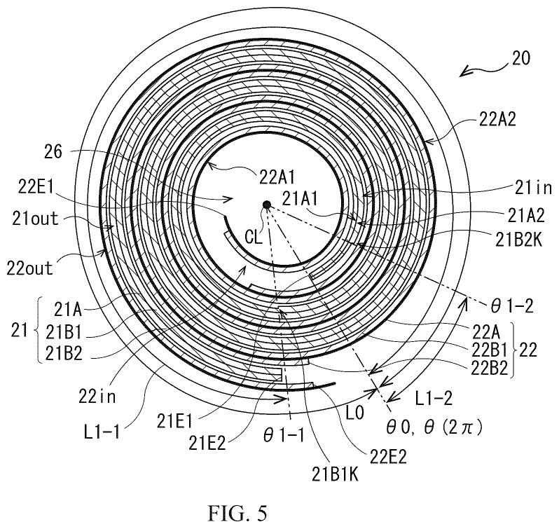

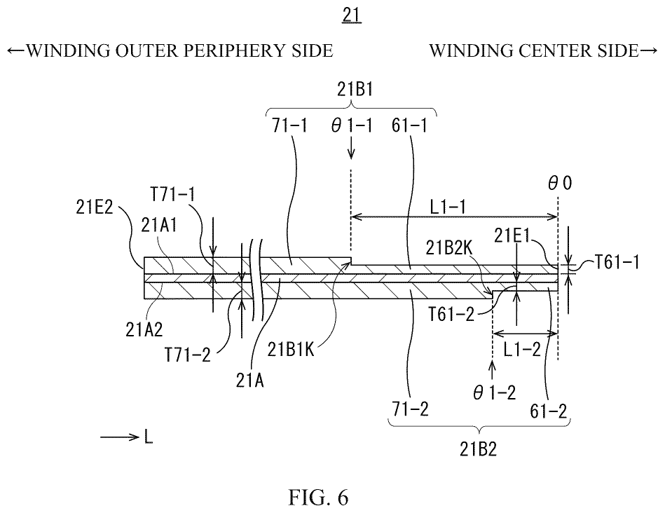

Note that the configuration example illustrated in FIG. 3 may correspond to an example case where the ratio L1/L0, i.e., the ratio of the length L1 to the length L0, is about 0.5. For example, each of the borders 21BIK and 21B2K may be positioned on substantially exactly the opposite side of the central axis CL to the winding center side edge 21E1. In the configuration example illustrated in FIG. 3, both the position of the border 21B1K and the position of the border 21B2K may coincide with the position θ1. However, the electrode wound body 20 of the example embodiment is not limited to this example. In some embodiments, as illustrated in FIGS. 5 and 6, the position of the border 21BIK and the position of the border 21B2K may be different from each other. FIG. 5 illustrates a second configuration example of the electrode wound body 20 along the horizontal section orthogonal to the Z-axis direction. FIG. 6 illustrates a section, along the L direction, of the positive electrode 21 in the electrode wound body 20 illustrated in FIG. 5, and corresponds to FIG. 4C. In the configuration example illustrated in FIGS. 5 and 6, the length L1-1 and the length L1-2 may be different from each other, where the length L1-1 is the length from the position θ0 of the winding center side edge 21E1 of the positive electrode 21 to the position θ1-1 of the border 21BIK, and the length L1-2 is the length from the position θ0 to the position θ1-2 of the border 21B2K. The configuration example illustrated in FIGS. 5 and 6 may correspond to an example case where the length L1-1 is greater than the length L1-2. In some embodiments, however, the length L1-1 may be smaller than the length L1-2.

Note that to measure the length L0 and the length L1 (i.e., the lengths L1-1 and L1-2), for example, a computed tomography (CT) image of a section orthogonal to the Z-axis may be acquired, and the innermost one wind of the positive electrode 21 may be approximated with an appropriate curve such as a spline curve, based on the acquired CT image with use of any image processing software. The length L0 and the length L1 (i.e., the lengths L1-1 and L1-2) may be thereby determined. Herein, the innermost one wind may be a part, of the positive electrode 21, from a start point to an end point determined as follows. For example, the start point of the positive electrode 21 may be the winding center side edge 21E1 of the positive electrode 21 in the L direction. The end point of the positive electrode 21 may be a point at which a line segment from the winding center side edge 21E1, as the start point, to any point on the positive electrode 21 intersects the negative electrode 22 and that allows such a line segment to be the shortest.

The positive electrode current collector 21A may include an electrically conductive material such as aluminum, for example. The positive electrode current collector 21A may be, for example, a metal foil including a material such as aluminum or an aluminum alloy.

The positive electrode active material layer 21B may include, as a positive electrode active material, any one or more of positive electrode materials which lithium is insertable into and extractable from. In some embodiments, the positive electrode active material layer 21B may further include any one or more of other materials including, without limitation, a positive electrode binder and a positive electrode conductor. In some embodiments, the positive electrode material may be a lithium-containing compound. In some embodiments, the lithium-containing compound may be, for example but not limited to, a lithium-containing composite oxide or a lithium-containing phosphoric acid compound. The lithium-containing composite oxide may be an oxide including lithium and one or more of other elements, that is, one or more of elements other than lithium, as constituent elements. The lithium-containing composite oxide may have any of crystal structures including, without limitation, a layered rock-salt crystal structure and a spinel crystal structure, for example. The lithium-containing phosphoric acid compound may be a phosphoric acid compound including lithium and one or more of other elements as constituent elements. The lithium-containing phosphoric acid compound may have a crystal structure such as an olivine crystal structure, for example. Non-limiting examples of the other elements may include nickel (Ni), cobalt (Co), manganese (Mn), and iron (Fe). In some embodiments, the positive electrode active material layer 21B may include, as the positive electrode active material, at least one of lithium cobalt oxide, lithium nickel cobalt manganese oxide, or lithium nickel cobalt aluminum oxide. The positive electrode binder may include, for example, any one or more of materials including, without limitation, a synthetic rubber and a polymer compound. Non-limiting examples of the synthetic rubber may include a styrene-butadiene-based rubber, a fluorine-based rubber, and ethylene propylene diene. Non-limiting examples of the polymer compound may include polyvinylidene difluoride and polyimide. The positive electrode conductor may include, for example, any one or more of materials including, without limitation, a carbon material. Non-limiting examples of the carbon material may include graphite, carbon black, acetylene black, and Ketjen black. In some embodiments, the positive electrode conductor may be any of electrically conductive materials, and may be, for example, a metal material or an electrically conductive polymer.

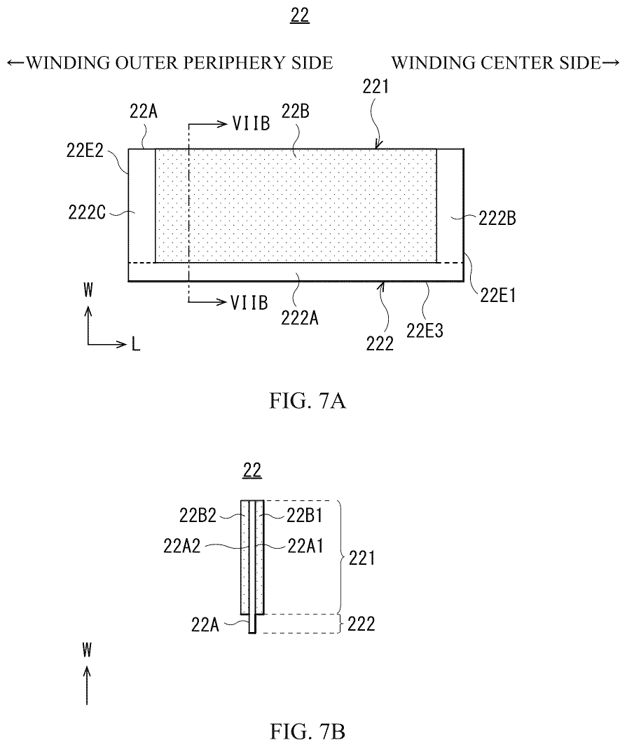

FIG. 7A is a developed view of the negative electrode 22, and schematically illustrates a state before being wound. FIG. 7B illustrates a sectional configuration of the negative electrode 22. Note that FIG. 7B illustrates a section as viewed in an arrowed direction along line VIIB-VIIB illustrated in FIG. 7A. The negative electrode 22 may include, for example, a negative electrode current collector 22A and a negative electrode active material layer 22B. The negative electrode active material layer 22B may cover a part of the negative electrode current collector 22A. In some embodiments, the negative electrode active material layer 22B may be provided, for example, simply on one of two opposite surfaces of the negative electrode current collector 22A. In some embodiments, the negative electrode active material layer 22B may be provided, for example, on each of the two opposite surfaces of the negative electrode current collector 22A. FIG. 7B illustrates an example case where the negative electrode active material layer 22B is provided on each of the two opposite surfaces of the negative electrode current collector 22A. For example, the negative electrode current collector 22A may include an inward negative electrode current collector surface 22A1 facing toward the central axis CL, and an outward negative electrode current collector surface 22A2 positioned on an opposite side to the inward negative electrode current collector surface 22A1. The negative electrode 22 may include an inner winding side negative electrode active material layer 22B1 and an outer winding side negative electrode active material layer 22B2, as the negative electrode active material layers 22B. The inner winding side negative electrode active material layer 22B1 may cover all or a part of the inward negative electrode current collector surface 22A1. The outer winding side negative electrode active material layer 22B2 may cover all or a part of the outward negative electrode current collector surface 22A2. Herein, the inner winding side negative electrode active material layer 22B1 and the outer winding side negative electrode active material layer 22B2 may each be generically referred to as the negative electrode active material layer 22B, without being distinguished from each other.

The negative electrode 22 may include a negative electrode covered region 221 and a negative electrode exposed region 222. The negative electrode covered region 221 may be a region in which the negative electrode current collector 22A is covered with the negative electrode active material layer 22B. The negative electrode exposed region 222 may be a region in which the negative electrode current collector 22A is exposed without being covered with the negative electrode active material layer 22B. As illustrated in FIG. 7A, the negative electrode covered region 221 and the negative electrode exposed region 222 may each extend along the L direction. The negative electrode exposed region 222 may extend from the winding center side edge 22E1 of the negative electrode 22 to a winding outer periphery side edge 22E2 of the negative electrode 22, i.e., an edge of the negative electrode 22 on the winding outer periphery side in the L direction, in the winding direction of the electrode wound body 20. In contrast, the negative electrode covered region 221 may be provided at neither the winding center side edge 22E1 of the negative electrode 22 nor the winding outer periphery side edge 22E2 of the negative electrode 22. As illustrated in FIG. 7A, parts of the negative electrode exposed region 222 may be so provided as to allow the negative electrode covered region 221 to be interposed therebetween in the L direction. For example, the negative electrode exposed region 222 may include a first part 222A, a second part 222B, and a third part 222C. The negative electrode 22 may further have a lower edge 22E3 that extends in the L direction on the lower side of the electrode wound body 20. The first part 222A may be provided to be adjacent to the negative electrode covered region 221 in the W direction, and may extend from the winding center side edge 22E1 of the negative electrode 22 to the winding outer periphery side edge 22E2 of the negative electrode 22 in the L direction. For example, the first part 222A may be a region extending from the negative electrode active material layer 22B in the W direction. The second part 222B and the third part 222C may be so provided as to allow the negative electrode covered region 221 to be interposed therebetween in the L direction. The first part 222A may be positioned in a region including the lower edge 22E3 and the vicinity thereof in the negative electrode 22. For example, the second part 222B may be positioned in a region including the winding center side edge 22E1 and the vicinity thereof in the negative electrode 22, and the third part 222C may be positioned in a region including the winding outer periphery side edge 22E2 and the vicinity thereof in the negative electrode 22. Note that FIGS. 7A and 7B each schematically illustrate the negative electrode current collector 22A in the straightened state along the W direction. In actuality, however, as illustrated in FIG. 1, a negative electrode edge part 222E of the negative electrode exposed region 222 may be bent toward the central axis CL and may be coupled to the negative electrode current collector plate 25. For example, an end part of the negative electrode exposed region 222 in the W direction may form the lower end face 42 and may be coupled to the negative electrode current collector plate 25, as illustrated in FIG. 1. The lower end face 42 may be a part, of the negative electrode edge part 222E of the negative electrode exposed region 222, that is bent toward the through hole 26 in a state where the electrode wound body 20 is wound.

The negative electrode current collector 22A may include an electrically conductive material such as copper, for example. The negative electrode current collector 22A may be, for example, a metal foil including a material such as nickel, a nickel alloy, copper, or a copper alloy. In some embodiments, a surface of the negative electrode current collector 22A may be roughened. One reason for this is that this helps to improve adherence of the negative electrode active material layer 22B to the negative electrode current collector 22A, owing to what is called an anchor effect. In this case, it may suffice that the surface of the negative electrode current collector 22A is roughened at least in a region facing the negative electrode active material layer 22B. Non-limiting examples of a roughening method may include a method in which microparticles are formed through an electrolytic treatment. In the electrolytic treatment, the microparticles may be formed on the surface of the negative electrode current collector 22A by an electrolytic method in an electrolyzer. This may provide the surface of the negative electrode current collector 22A with asperities. A copper foil fabricated by the electrolytic method may be generally called an electrolytic copper foil.

The negative electrode active material layer 22B may include, as a negative electrode active material, any one or more of negative electrode materials which lithium is insertable into and extractable from. In some embodiments, the negative electrode active material layer 22B may further include any one or more of other materials including, without limitation, a negative electrode binder and a negative electrode conductor. The negative electrode material may be, for example but not limited to, a carbon material. One reason for this is that the carbon material exhibits very little change in crystal structure at the time of insertion and extraction of lithium, which helps to stably obtain a high energy density. Another reason is that the carbon material also serves as the negative electrode conductor, which helps to improve electrical conductivity of the negative electrode active material layer 22B. The carbon material may be, for example but not limited to, graphitizable carbon, non-graphitizable carbon, or graphite. In some embodiments, spacing of a (002) plane of the non-graphitizable carbon may be 0.37 nm or greater. In some embodiments, spacing of a (002) plane of the graphite may be 0.34 nm or less. Non-limiting examples of the carbon material may include pyrolytic carbons, cokes, glassy carbon fibers, an organic polymer compound fired body, activated carbon, and carbon blacks. Non-limiting examples of the cokes may include pitch coke, needle coke, and petroleum coke. The organic polymer compound fired body may be a resultant of firing or carbonizing a polymer compound such as a phenol resin or a furan resin at a suitable temperature. Other than the above, in some embodiments, the carbon material may be low-crystalline carbon heat-treated at a temperature of about 1000° C. or lower. In some embodiments, the carbon material may be amorphous carbon. In some embodiments, the carbon material may have any of a fibrous shape, a spherical shape, a granular shape, or a flaky shape. In the secondary battery 1, when an open-circuit voltage in a fully charged state, that is, a battery voltage, is 4.25 V or higher, the amount of extracted lithium per unit mass may increase as compared with when the open-circuit voltage in the fully charged state is 4.20 V, even with the same positive electrode active material. The amount of the positive electrode active material and the amount of the negative electrode active material may be therefore adjusted accordingly. This helps to obtain a high energy density.

In some embodiments, the negative electrode active material layer 22B may include, as the negative electrode active material, a silicon-containing material including at least one of silicon, a silicon oxide, a carbon-silicon compound, or a silicon alloy. The term “silicon-containing material” may be a generic term for a material that includes silicon as a constituent element. In some embodiments, the silicon-containing material may include only silicon as a constituent element. In some embodiments, only one kind of silicon-containing material may be used. In some embodiments, two or more kinds of silicon-containing materials may be used. The silicon-containing material may be able to form an alloy with lithium, and may be: a simple substance of silicon; a silicon alloy; a silicon compound; a mixture of two or more of a simple substance of silicon, a silicon alloy, or a silicon compound; or a material including one or more phases of a simple substance of silicon, a silicon alloy, and a silicon compound. The silicon-containing material may be crystalline or amorphous, or may include both a crystalline part and an amorphous part. Note that the simple substance described here may refer to a simple substance merely in a general sense. In some embodiments, the simple substance may thus include a small amount of impurity. In other words, purity of the simple substance is not necessarily limited to 100%. The silicon alloy may include, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound may include, as one or more constituent elements other than silicon, any one or more of elements including, without limitation, carbon and oxygen, for example. In some embodiments, the silicon compound may include, as one or more constituent elements other than silicon, any one or more of the series of constituent elements described above in relation to the silicon alloy, for example. Non-limiting examples of the silicon alloy and the silicon compound may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, and SiOᵥ (where 0<v≤2). Note that the range of v may be chosen as desired, and may be, for example, 0.2<v<1.4.

In the stacked body S20 of the electrode wound body 20, the positive electrode 21 and the negative electrode 22 may be so stacked on each other with the separator 23 interposed therebetween that the positive electrode exposed region 212 and the first part 222A of the negative electrode exposed region 222 face toward mutually opposite directions along the W direction, i.e., the width direction. A fixing tape 46 may be attached to an intermediate region of a side surface 45 of the electrode wound body 20. In the electrode wound body 20, an end part of the separator 23 may be fixed by attaching the fixing tape 46 to the intermediate region of the side surface 45 to thereby prevent loosening of winding.

In some embodiments, as illustrated in FIG. 2, the secondary battery 1 may satisfy A>B, where A is a width of the positive electrode exposed region 212, and B is a width of the first part 222A of the negative electrode exposed region 222. For example, when the width A is 7 (mm), the width B may be 4 (mm). In some embodiments, the secondary battery 1 may satisfy C>D, where C is a width of a part of the positive electrode exposed region 212 protruding from an outer edge in the width direction of the separator 23, and D is a width of a part of the first part 222A of the negative electrode exposed region 222 protruding from an opposite outer edge in the width direction of the separator 23. For example, when the width C is 4.5 (mm), the width D may be 3 (mm).

As illustrated in FIG. 1, in the upper part of the secondary battery 1, multiple parts of the positive electrode edge part 212E, of the positive electrode exposed region 212 wound around the central axis CL, that are adjacent to each other in a radial direction, i.e., an R direction, of the electrode wound body 20 may be so bent toward the central axis CL as to overlap each other. The parts of the positive electrode edge part 212E may thus form the upper end face 41 of the electrode wound body 20. Similarly, in the lower part of the secondary battery 1, multiple parts of the negative electrode edge part 222E, of the negative electrode exposed region 222 wound around the central axis CL, that are adjacent to each other in the radial direction, i.e., the R direction, may be so bent toward the central axis CL as to overlap each other. The parts of the negative electrode edge part 222E may thus form the lower end face 42 of the electrode wound body 20. Accordingly, the parts of the positive electrode edge part 212E of the positive electrode exposed region 212 may gather at the upper end face 41 of the electrode wound body 20, and the parts of the negative electrode edge part 222E of the negative electrode exposed region 222 may gather at the lower end face 42 of the electrode wound body 20. To achieve better contact between the positive electrode current collector plate 24 for extracting a current and the positive electrode edge part 212E, the parts of the positive electrode edge part 212E bent toward the central axis CL may form a flat surface. Similarly, to achieve better contact between the negative electrode current collector plate 25 for extracting a current and the negative electrode edge part 222E, the parts of the negative electrode edge part 222E bent toward the central axis CL may form a flat surface. Note that as used herein, the term “flat surface” may encompass not only a completely flat surface but also a surface having some asperities or surface roughness to the extent that joining of the positive electrode exposed region 212 to the positive electrode current collector plate 24 and joining of the negative electrode exposed region 222 to the negative electrode current collector plate 25 are possible.

The positive electrode current collector 21A may include an electrically conductive foil such as an aluminum foil, as described above. The negative electrode current collector 22A may include an electrically conductive foil such as a copper foil, as described above. In this case, the positive electrode current collector 21A may be softer than the negative electrode current collector 22A. For example, the positive electrode exposed region 212 may have a Young's modulus lower than a Young's modulus of the negative electrode exposed region 222. Accordingly, in some embodiments, the secondary battery 1 may satisfy both A>B and C>D regarding the widths A to D. In such a case, when the positive electrode exposed region 212 and the negative electrode exposed region 222 are substantially simultaneously bent with substantially equal pressures from both electrode sides, the bent part in the positive electrode 21 and the bent part in the negative electrode 22 may sometimes become substantially equal in height measured from respective ends of the separator 23. In this case, the parts of the positive electrode edge part 212E of the positive electrode exposed region 212 illustrated in FIG. 1 may appropriately overlap each other by being bent. This helps to allow for easy joining of the positive electrode exposed region 212 and the positive electrode current collector plate 24 to each other. Similarly, the parts of the negative electrode edge part 222E of the negative electrode exposed region 222 illustrated in FIG. 1 may appropriately overlap each other by being bent. This helps to allow for easy joining of the negative electrode exposed region 222 and the negative electrode current collector plate 25 to each other. As used herein, the term “joining” may refer to coupling by, for example, laser welding; however, a method of joining is not limited to laser welding. In some embodiments, any other suitable coupling method may be used.

As illustrated in FIG. 2, a part, of the positive electrode exposed region 212 of the positive electrode 21, that is opposed to the negative electrode 22 with the separator 23 interposed therebetween may be covered with the insulating layer 101. The insulating layer 101 may have a width of 3 mm in the W direction, for example. The insulating layer 101 may entirely cover a part, of the positive electrode exposed region 212 of the positive electrode 21, that is opposed to the negative electrode covered region 221 of the negative electrode 22 with the separator 23 interposed therebetween. The insulating layer 101 helps to effectively prevent an internal short circuit of the secondary battery 1 when foreign matter enters between the negative electrode covered region 221 and the positive electrode exposed region 212, for example. Further, when the secondary battery 1 undergoes an impact, the insulating layer 101 absorbs the impact, thereby helping to effectively prevent, for example, bending of the positive electrode exposed region 212 or a short circuit between the positive electrode exposed region 212 and the negative electrode 22.

The secondary battery 1 may further include insulating members 53 and 54 in a gap between the outer package can 11 and the electrode wound body 20. The positive electrode exposed region 212 having parts gathering at the upper end face 41 and the negative electrode exposed region 222 having parts gathering at the lower end face 42 may be electrical conductors, such as metal foils, that are exposed. Accordingly, if the positive electrode exposed region 212 and the negative electrode exposed region 222 are in close proximity to the outer package can 11, a short circuit between the positive electrode 21 and the negative electrode 22 can occur via the outer package can 11. A short circuit can also occur when the positive electrode current collector plate 24 on the upper end face 41 and the outer package can 11 come into close proximity to each other. To address this, in some embodiments, the insulating members 53 and 54 may be provided. Providing the insulating members 53 and 54 helps to protect the electrode wound body 20 when the electrode wound body 20 is to be placed into the outer package can 11 or when the safety valve mechanism 30 is to be attached in a manufacturing process to be described later. In addition, providing the insulating members 53 and 54 helps to prevent the electrode wound body 20 from coming into contact with another component of the secondary battery 1 when the electrode wound body 20 expands due to charging, and to thus protect the electrode wound body 20. Each of the insulating members 53 and 54 may be an adhesive tape including a base layer and an adhesive layer provided on one surface of the base layer. The base layer may include, for example, any one of polypropylene, polyethylene terephthalate, or polyimide. To prevent the provision of the insulating members 53 and 54 from resulting in a decreased capacity of the electrode wound body 20, the insulating members 53 and 54 are disposed not to overlap the fixing tape 46 attached to the side surface 45, and each have a thickness set to be less than or equal to a thickness of the fixing tape 46.

### [Positive Electrode Current Collector Plate 24 and Negative Electrode Current Collector Plate 25]

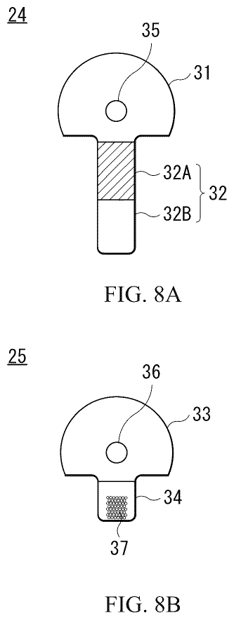

In a general lithium-ion secondary battery, for example, a lead for current extraction is welded to each of a positive electrode and a negative electrode. However, such a structure increases an internal resistance of the lithium-ion secondary battery, causing the lithium-ion secondary battery to generate heat and become hot upon discharging; therefore, the structure is unsuitable for discharging at a high rate. To address this, in the secondary battery 1 according to the present example embodiment, the positive electrode current collector plate 24 may be disposed to face the upper end face 41, and the negative electrode current collector plate 25 may be disposed to face the lower end face 42. In addition, the positive electrode exposed region 212 that forms the upper end face 41 and the positive electrode current collector plate 24 may be welded to each other at multiple points; and the negative electrode exposed region 222 that forms the lower end face 42 and the negative electrode current collector plate 25 may be welded to each other at multiple points. This helps to allow for a reduced internal resistance of the secondary battery 1. Each of the upper end face 41 and the lower end face 42 being a flat surface as described above also contributes to the reduced resistance. The positive electrode current collector plate 24 may be disposed between the battery cover 14 and the upper end face 41. The positive electrode current collector plate 24 may be electrically coupled to the battery cover 14 via the safety valve mechanism 30, for example. The negative electrode current collector plate 25 may be disposed between the bottom part 11B of the outer package can 11 and the lower end face 42. The negative electrode current collector plate 25 may be electrically coupled to an inner surface of the bottom part 11B of the outer package can 11, for example. FIG. 8A is a developed diagram illustrating a configuration example of the positive electrode current collector plate 24. FIG. 8B is a developed diagram illustrating a configuration example of the negative electrode current collector plate 25. The positive electrode current collector plate 24 may be a metal plate including, for example but not limited to, aluminum or an aluminum alloy as a single component, or a composite material of aluminum and the aluminum alloy. The negative electrode current collector plate 25 may be a metal plate including, for example but not limited to, nickel, a nickel alloy, copper, or a copper alloy as a single component, or a composite material of two or more thereof.

As illustrated in FIG. 8A, the positive electrode current collector plate 24 may include a fan-shaped part 31 and a band-shaped part 32. The fan-shaped part 31 may have a substantially fan shape. The band-shaped part 32 may have a substantially rectangular shape. A shape of the positive electrode current collector plate 24 is, however, not limited to the shape illustrated in FIG. 8A, and may be chosen as desired. Note that in the secondary battery 1, the positive electrode current collector plate 24 may be contained inside the outer package can 11, as illustrated in FIG. 1, in a state where the band-shaped part 32 is bent with respect to the fan-shaped part 31. FIG. 8A illustrates the positive electrode current collector plate 24 in an unbent state. The fan-shaped part 31 may be a facing part facing and coupled to the upper end face 41. The fan-shaped part 31 may have an outer edge including a linear part and a curved part, for example. The fan-shaped part 31 may have an opening 35 in the vicinity of a middle thereof. FIG. 8A illustrates an example case where the opening 35 has a circular plan shape in a horizontal plane orthogonal to the Z-axis direction. The band-shaped part 32 may be coupled to the linear part of the outer edge of the fan-shaped part 31, for example. The band-shaped part 32 may extend in a direction intersecting with the linear part of the fan-shaped part 31. As illustrated in FIG. 1, in the secondary battery 1, the positive electrode current collector plate 24 may be so provided as to allow the opening 35 to overlap the through hole 26 in the Z-axis direction. For example, the opening 35 may be positioned to overlap, in the Z-axis direction, a part of the upper end face 41 on the winding center side.

A hatched part in FIG. 8A represents an insulating part 32A of the band-shaped part 32. The insulating part 32A may be a part of the band-shaped part 32 and may have an insulating member attached thereto or an insulating material applied thereto. Of the band-shaped part 32, a part below the insulating part 32A may be a coupling part 32B to be coupled to a sealing plate that also serves as an external terminal. The sealing plate may be electrically continuous with the battery cover 14. Note that when the secondary battery 1 has a battery structure without a metallic center pin in the through hole 26 as illustrated in FIG. 1, there is a low possibility that the band-shaped part 32 will come into contact with a region of a negative electrode potential. In some embodiments, the positive electrode current collector plate 24 does not have to include the insulating part 32A. When the positive electrode current collector plate 24 does not include the insulating part 32A, a charge and discharge capacity is allowed to be increased by increasing a width of each of the positive electrode 21 and the negative electrode 22 by an amount corresponding to a thickness of the insulating part 32A.

The negative electrode current collector plate 25 illustrated in FIG. 8B may have a shape similar to the shape of the positive electrode current collector plate 24 illustrated in FIG. 8A. The negative electrode current collector plate 25 may include a fan-shaped part 33 and a band-shaped part 34. The fan-shaped part 33 may have a substantially fan shape. The band-shaped part 34 may have a substantially rectangular shape. The shape of the negative electrode current collector plate 25 is, however, not limited to the shape illustrated in FIG. 8B, and may be chosen as desired. Note that in the secondary battery 1, the negative electrode current collector plate 25 may be contained inside the outer package can 11, as illustrated in FIG. 1, in a state where the band-shaped part 34 is bent with respect to the fan-shaped part 33. FIG. 8B illustrates the negative electrode current collector plate 25 in an unbent state. The fan-shaped part 33 may be a facing part facing and coupled to the lower end face 42. The fan-shaped part 33 may have an outer edge including a linear part and a curved part, for example. The band-shaped part 34 may be coupled to the linear part of the outer edge of the fan-shaped part 33, for example. The band-shaped part 34 may extend in a direction intersecting with the linear part of the fan-shaped part 33. The band-shaped part 34 of the negative electrode current collector plate 25 may be shorter than the band-shaped part 32 of the positive electrode current collector plate 24, and may include no part corresponding to the insulating part 32A of the positive electrode current collector plate 24. The band-shaped part 34 may be provided with projections 37 that are depicted as circles. The projections 37 may each be of a round shape. All or a part of the projections 37 may be welded to the bottom part 11B of the outer package can 11. Upon resistance welding, a current may be concentrated on the projections 37, causing the projections 37 to melt to cause the band-shaped part 34 to be welded to the bottom part 11B of the outer package can 11. As with the positive electrode current collector plate 24, the negative electrode current collector plate 25 may have an opening 36 in the vicinity of a middle of the fan-shaped part 33. In the secondary battery 1, the negative electrode current collector plate 25 may be so provided as to allow the opening 36 to overlap the through hole 26 in the Z-axis direction. FIG. 8B illustrates an example case where the opening 36 has a circular plan shape in a horizontal plane orthogonal to the Z-axis direction.

The fan-shaped part 31 of the positive electrode current collector plate 24 may simply cover a part of the upper end face 41, owing to a plan shape of the fan-shaped part 31. Similarly, the fan-shaped part 33 of the negative electrode current collector plate 25 may simply cover a part of the lower end face 42, owing to a plan shape of the fan-shaped part 33. Reasons why the fan-shaped part 31 and the fan-shaped part 33 do not respectively cover the entire upper end face 41 and the entire lower end face 42 include, for example but not limited to, the following reasons. One reason is to allow the electrolytic solution to smoothly permeate the electrode wound body 20 in assembling the secondary battery 1, for example. In the secondary battery 1 according to the present example embodiment, the positive electrode current collector plate 24 may be so provided as to allow the opening 35 to overlap a part of the upper end face 41 on the winding center side in the Z-axis direction. Accordingly, one or more, but not all, of the parts of the positive electrode edge part 212E forming the upper end face 41 may not be covered with the fan-shaped part 31 of the positive electrode current collector plate 24 and may be exposed from the opening 35. The secondary battery 1 may thus have a structure that allows for swifter permeation of the electrolytic solution into the electrode wound body 20. Another reason is to allow a gas generated when the lithium-ion secondary battery comes into an abnormally hot state or an overcharged state to be easily released to the outside.

The separator 23 may be interposed between the positive electrode 21 and the negative electrode 22. The separator 23 may allow lithium ions to pass through and prevent a short circuit of a current caused by contact between the positive electrode 21 and the negative electrode 22. The separator 23 may include, for example, any one or more kinds of porous films each including, for example but not limited to, a synthetic resin or a ceramic. In some embodiments, the separator 23 may include, for example, a stacked film including two or more kinds of porous films. Non-limiting examples of the synthetic resin may include polytetrafluoroethylene, polypropylene, and polyethylene. In some embodiments, the separator 23 may include a base that includes a single-layer polyolefin porous film including polyethylene. One reason for this is that this helps to obtain a favorable high output characteristic, as compared with the stacked film. In some embodiments, when each of the first separator member 23A and the second separator member 23B included in the separator 23 is a single-layer porous film including polyolefin, the single-layer porous film including polyolefin may have a thickness of greater than or equal to 10 μm and less than or equal to 15 μm, for example. Allowing the single-layer porous film including polyolefin to have a thickness of greater than or equal to 10 μm helps to sufficiently avoid an internal short circuit. Allowing the single-layer porous film including polyolefin to have a thickness of less than or equal to 15 μm helps to achieve a more favorable discharge capacity characteristic. In some embodiments, the single-layer porous film including polyolefin may have a surface density of greater than or equal to 6.3 g/m² and less than or equal to 8.3 g/m², for example. Allowing the single-layer porous film including polyolefin to have a surface density of greater than or equal to 6.3 g/m² helps to sufficiently avoid an internal short circuit. Allowing the single-layer porous film including polyolefin to have a surface density of less than or equal to 8.3 g/m² helps to achieve a more favorable discharge capacity characteristic.

In some embodiments, the separator 23 may include, for example, a porous film as the base described above, and a polymer compound layer provided on one of or each of two opposite surfaces of the base. One reason for this is that adherence of the separator 23 to each of the positive electrode 21 and the negative electrode 22 improves, which suppresses distortion of the electrode wound body 20. As a result, a decomposition reaction of the electrolytic solution is suppressed, and leakage of the electrolytic solution with which the base is impregnated is also suppressed. This helps to prevent an easy increase in resistance even upon repeated charging and discharging, and also to suppress swelling of the secondary battery. The polymer compound layer may include, for example, a polymer compound such as polyvinylidene difluoride. One reason for this is that the polymer compound such as polyvinylidene difluoride has superior physical strength and is electrochemically stable. In some embodiments, the polymer compound may be other than polyvinylidene difluoride. To form the polymer compound layer, for example, a solution in which the polymer compound is dissolved in a solvent such as an organic solvent may be applied on the base, following which the base may be dried. In some embodiments, the base may be immersed in the solution and thereafter dried. In some embodiments, the polymer compound layer may include any one or more kinds of insulating particles such as inorganic particles, for example. Non-limiting examples of the kind of the material included in the inorganic particles may include aluminum oxide and aluminum nitride.

The electrolytic solution may include a solvent and an electrolyte salt. In some embodiments, the electrolytic solution may further include any one or more of other materials. Non-limiting examples of the other materials may include an additive. The solvent may include any one or more of nonaqueous solvents including, without limitation, an organic solvent. An electrolytic solution including a nonaqueous solvent may be what is called a nonaqueous electrolytic solution. The nonaqueous solvent may include a fluorine compound and a dinitrile compound, for example. The fluorine compound may include, for example, at least one of fluorinated ethylene carbonate, trifluorocarbonate, trifluoroethyl methyl carbonate, a fluorinated carboxylic acid ester, or a fluorine ether. In some embodiments, the nonaqueous solvent may further include one or more of nitrile compounds other than the dinitrile compound. Non-limiting examples of the nitrile compounds other than the dinitrile compound may include a mononitrile compound and a trinitrile compound. In some embodiments, the dinitrile compound may include succinonitrile (SN). However, the dinitrile compound is not limited to succinonitrile, and in some embodiments, may be any other dinitrile compound such as adiponitrile.

The electrolyte salt may include, for example, any one or more of salts including, without limitation, a lithium salt. In some embodiments, the electrolyte salt may include a salt other than the lithium salt. Non-limiting examples of the salt other than the lithium salt may include a salt of a light metal other than lithium. Non-limiting examples of the lithium salt may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In some embodiments, the lithium salt may include any one or more of LiPF₆, LiBF₄, LiClO₄, or LiAsF₆. In some embodiments, the lithium salt may be LiPF₆. A content of the electrolyte salt is not particularly limited. In some embodiments, the content of the electrolyte salt may be within a range from 0.3 mol/kg to 3 mol/kg both inclusive with respect to the solvent. In some embodiments, when the electrolytic solution includes LiPF₆ as the electrolyte salt, a concentration of LiPF₆ in the electrolytic solution may be within a range from 1.25 mol/kg to 1.45 mol/kg both inclusive. One reason for this is that this helps to prevent cycle deterioration caused by consumption or decomposition of the salt at the time of high load rate charging, and thus helps to improve a high-load cyclability characteristic. In some embodiments, when the electrolytic solution further includes LiBF₄ in addition to LiPF₆ as the electrolyte salt, a concentration of LiBF₄ in the electrolytic solution may be within a range from 0.001 wt % to 0.1 wt % both inclusive. One reason for this is that this helps to more effectively prevent the cycle deterioration caused by consumption or decomposition of the salt at the time of high load rate charging, and thus helps to further improve the high-load cyclability characteristic.

In the secondary battery 1 according to the present example embodiment, for example, upon charging, lithium ions may be extracted from the positive electrode 21, and the extracted lithium ions may be inserted into the negative electrode 22 via the electrolytic solution. In the secondary battery 1, for example, upon discharging, lithium ions may be extracted from the negative electrode 22, and the extracted lithium ions may be inserted into the positive electrode 21 via the electrolytic solution.

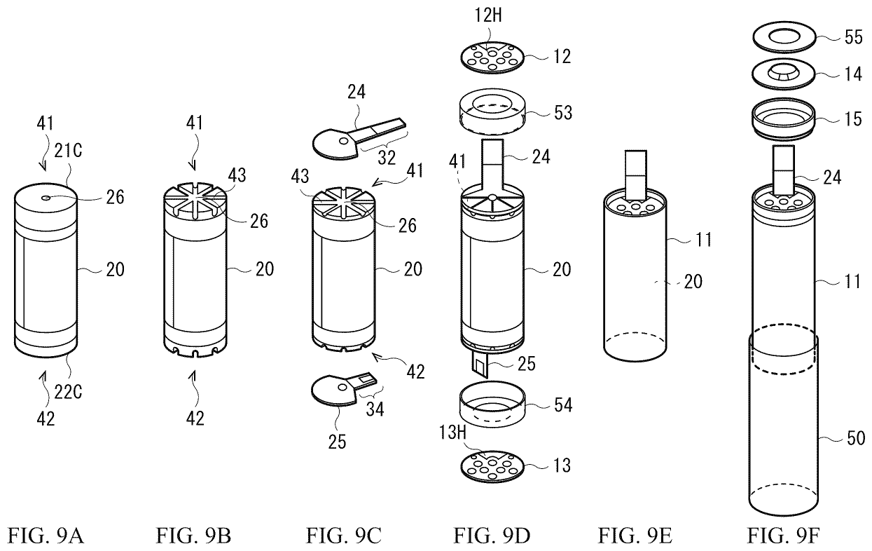

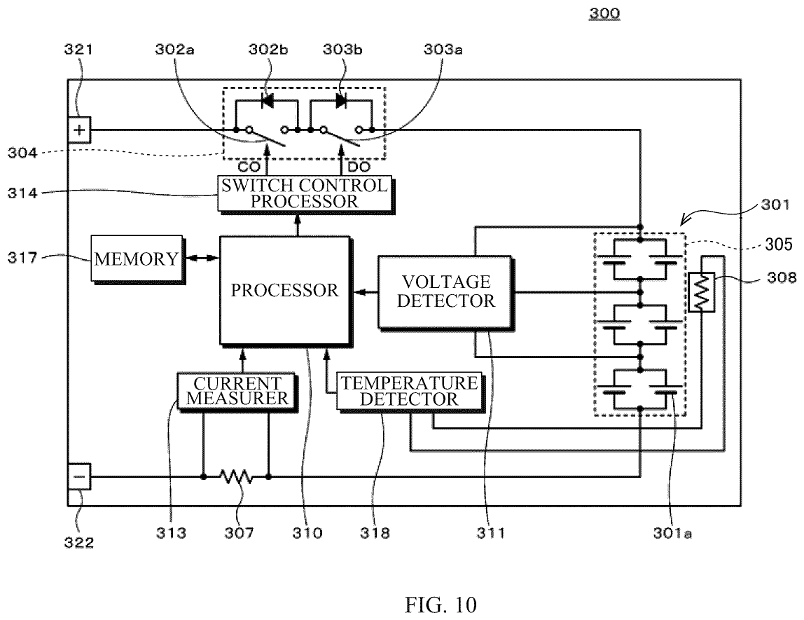

A method of manufacturing the secondary battery 1 will be described with reference to FIGS. 9A to 9F as well as FIGS. 1 to 8B. FIGS. 9A to 9F are each a perspective diagram describing a process of manufacturing the secondary battery 1 illustrated in FIG. 1.

First, the positive electrode current collector 21A may be prepared, and the positive electrode active material layer 21B may be selectively formed on one of or each of the two opposite surfaces of the positive electrode current collector 21A. Thereafter, the insulating layer 101 may be formed on the surface of the positive electrode current collector 21A, along the first end face 21BT1 of the positive electrode active material layer 21B. Thereafter, a predetermined region of the positive electrode active material layer 21B may be partially removed by a method such as laser ablation to thereby form the thin part 61. The positive electrode 21 may thus be obtained by the above-described operation. Thereafter, the negative electrode current collector 22A may be prepared, and the negative electrode active material layer 22B may be selectively formed on one of or each of the two opposite surfaces of the negative electrode current collector 22A to thereby form the negative electrode 22 including the negative electrode covered region 221 and the negative electrode exposed region 222. In some embodiments, the positive electrode 21 and the negative electrode 22 may be subjected to a drying process. Thereafter, the positive electrode 21 and the negative electrode 22 may be stacked, with the first separator member 23A and the second separator member 23B on the positive electrode 21 and the negative electrode 22, respectively, to cause the positive electrode exposed region 212 and the first part 222A of the negative electrode exposed region 222 to be on opposite sides to each other in the W direction. The stacked body S20 may thus be fabricated. Thereafter, the stacked body S20 may be so wound in a spiral shape as to form the through hole 26. Upon thus winding the stacked body S20, for example, a circular columnar winding core may be used as a jig, and the stacked body S20 may be wound around the circular columnar winding core. In addition, the fixing tape 46 may be attached to an outermost wind of the stacked body S20 wound in the spiral shape, following which the winding core may be removed. The electrode wound body 20 may thus be obtained as illustrated in FIG. 9A.

Thereafter, a part of the upper end face 41 and a part of the lower end face 42 of the electrode wound body 20 may each be locally bent by pressing an end of, for example, a plate-shaped member having a wedge-shaped section against each of the upper end face 41 and the lower end face 42 perpendicularly, that is, in the Z-axis direction. This process may be referred to as first pressing. As a result, multiple grooves 43 may be formed to extend radiately in radial directions (R directions) from the through hole 26, on each of the upper end face 41 and the lower end face 42, as illustrated in FIG. 9B. Note that the number and arrangement of the grooves 43 illustrated in FIG. 9B are merely examples, and an embodiment of the present disclosure is not limited thereto. In some embodiments, the number of the grooves 43 may be any other number, and the grooves 43 may be arranged in any other way.

Thereafter, substantially equal pressures may be applied to the upper end face 41 and the lower end face 42 substantially perpendicularly from above and below the electrode wound body 20 at substantially the same time. This process may be referred to as second pressing. At this time, for example, a rod-shaped jig may be placed in the through hole 26 in advance. By this operation, the positive electrode exposed region 212 and the first part 222A of the negative electrode exposed region 222 may be bent to respectively make the upper end face 41 and the lower end face 42 into flat surfaces, as illustrated in FIG. 9C. In some embodiments, at this time, the parts, of the positive electrode edge part 212E of the positive electrode exposed region 212 at the upper end face 41, that are adjacent to each other in the radial direction of the electrode wound body 20 may be so bent toward the through hole 26 as to overlap each other. Similarly, in some embodiments, the parts, of the negative electrode edge part 222E of the negative electrode exposed region 222 at the lower end face 42, that are adjacent to each other in the radial direction of the electrode wound body 20 may be so bent toward the through hole 26 as to overlap each other. Thereafter, the fan-shaped part 31 of the positive electrode current collector plate 24 may be joined to the upper end face 41 by a method such as laser welding, and the fan-shaped part 33 of the negative electrode current collector plate 25 may be joined to the lower end face 42 by a method such as laser welding.

Thereafter, as illustrated in FIG. 9D, the insulating members 53 and 54 may be attached to respective predetermined locations on the electrode wound body 20. Thereafter, the band-shaped part 32 of the positive electrode current collector plate 24 may be bent and passed through a hole 12H of the insulating plate 12. Further, the band-shaped part 34 of the negative electrode current collector plate 25 may be bent and passed through a hole 13H of the insulating plate 13.

Thereafter, as illustrated in FIG. 9E, the electrode wound body 20 having been assembled in the above-described manner may be placed into the outer package can 11, following which the bottom part 11B of the outer package can 11 and the negative electrode current collector plate 25 may be welded to each other. Thereafter, the narrow part 11S may be formed in the vicinity of the open end part 11N of the outer package can 11 as illustrated in FIG. 1. Further, the electrolytic solution may be injected into the outer package can 11, following which the band-shaped part 32 of the positive electrode current collector plate 24 and the safety valve mechanism 30 may be welded to each other.

Thereafter, as illustrated in FIG. 9F, the outer package can 11 may be sealed with the gasket 15, the safety valve mechanism 30, and the battery cover 14, through the use of the narrow part 11S. Thereafter, the outer package can 11 with the washer 55 attached on the battery cover 14 may be covered with the outer package tube 50, following which the outer package tube 50 may be heated by, for example, applying hot air to the outer package tube 50. The outer package tube 50 may thus be contracted and closely attached to the outer surface of the outer package can 11.

The secondary battery 1 according to the present example embodiment may thus be completed.

As described above, in the secondary battery 1 of the present example embodiment, the thin part 61 that has a small thickness is provided at a part of the positive electrode active material layer 21B. This helps to reduce concentration of stress inside the electrode wound body 20 contained in the outer package can 11. For example, this helps to prevent great deformation, such as buckling or bending, of the positive electrode current collector 21A when the negative electrode 22 swells inside the electrode wound body 20 upon charging and discharging. One reason for this is that reducing the amount of the electrode reactant, such as lithium ions, supplied to a partial region of the negative electrode active material layer 22B opposed to the thin part 61 suppresses expansion and contraction of the partial region of the negative electrode active material layer 22B opposed to the thin part 61. As a result, stress applied to the separator 23 separating the positive electrode 21 and the negative electrode 22 from each other is also reduced, which helps to avoid breakage of the separator 23 even when the separator 23 has a reduced thickness, and to thereby prevent a short circuit between the positive electrode 21 and the negative electrode 22. In other words, it helps to allow for reduction in the thickness of the separator 23. The reduction in the thickness of the separator 23 allows a spacing between the positive electrode 21 and the negative electrode 22 to be reduced, which decreases the internal resistance of the electrode wound body 20. This helps to improve a rate characteristic at the time of charging and discharging and to increase the capacity of the secondary battery 1.

In addition, in the secondary battery 1 according to the present example embodiment, the position θ1 of the border 21B1K between the thin part 61 and the thick part 71 is different, in the radial direction of the electrode wound body 20, from the position overlapping the position θ0 of the winding center side edge 21E1 of the positive electrode 21. This helps to reduce stress applied to a part of the separator 23 opposed to the winding center side edge 21E1 of the positive electrode 21, caused by swelling of the negative electrode 22 accompanying charging and discharging. Such reduction in stress applied to the separator 23 helps to prevent the separator 23 from being easily crushed. Accordingly, the secondary battery 1 of the present example embodiment helps to achieve higher reliability.

In some embodiments, the thin part 61 may include the winding center side edge 21E1 of the positive electrode 21 in the L direction. Such a configuration helps to improve softness in a region at and near the winding center side edge 21E1 of the positive electrode 21. This helps to avoid an increase in a radius of curvature at and near the winding center of the electrode wound body 20. In addition, the positive electrode active material layer 21B may further include the thick part 71 provided on the opposite side of the thin part 61 to the winding center side edge 21E1 in the L direction. This helps to obtain a predetermined battery capacity while reducing concentration of stress at and near the winding center of the electrode wound body 20. For example, such a configuration of the secondary battery 1 helps to achieve a high volumetric density while ensuring reliability.

In some embodiments, in the positive electrode 21, the thin part 61 and the thick part 71 may both be provided on each of the inward positive electrode current collector surface 21A1 and the outward positive electrode current collector surface 21A2. Such a configuration helps to further reduce the concentration of the stress at and near the winding center of the electrode wound body 20.

In some embodiments, the secondary battery 1 may include a lithium-ion secondary battery. Such a configuration helps to allow a sufficient battery capacity to be obtained stably through insertion and extraction of lithium. This helps to achieve higher battery performance.

Non-limiting examples of applications of the secondary battery 1 according to an example embodiment of the present disclosure may be as described below.

FIG. 10 is a block diagram illustrating a circuit configuration example in which the secondary battery 1 according to the example embodiment of the present disclosure is applied to a battery pack 300. The battery pack 300 may include an assembled battery 301, a switcher 304, an outer package body 305, a current detection resistor 307, a temperature detection device 308, and a processor 310. The switcher 304 may include a charge control switch 302a and a discharge control switch 303a. The outer package body 305 may contain the assembled battery 301.

The battery pack 300 may include a positive electrode terminal 321 and a negative electrode terminal 322. Upon charging, the positive electrode terminal 321 and the negative electrode terminal 322 may be respectively coupled to a positive electrode terminal and a negative electrode terminal of a charger to perform charging. Upon use of electronic equipment, the positive electrode terminal 321 and the negative electrode terminal 322 may be respectively coupled to a positive electrode terminal and a negative electrode terminal of the electronic equipment to perform discharging.

The assembled battery 301 may include secondary batteries 301a coupled in series or in parallel. The secondary battery 1 described above is applicable to each of the secondary batteries 301a. FIG. 10 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration, where each of n and m is an integer.

The switcher 304 may include the charge control switch 302a, a diode 302b, the discharge control switch 303a, and a diode 303b, and may be controlled by the processor 310. The diode 302b may have a polarity that is in a reverse direction with respect to a charge current flowing in a direction from the positive electrode terminal 321 to the assembled battery 301, and that is in a forward direction with respect to a discharge current flowing in a direction from the negative electrode terminal 322 to the assembled battery 301. The diode 303b may have a polarity that is in the forward direction with respect to the charge current and in the reverse direction with respect to the discharge current. In FIG. 10, the switcher 304 may be provided on a positive side; however, in some embodiments, the switcher 304 may be provided on a negative side.

The charge control switch 302a may be so controlled by a charge and discharge control processor that when the battery voltage reaches an overcharge detection voltage, the charge control switch 302a is turned off to thereby prevent the charge current from flowing through a current path of the assembled battery 301. After the charge control switch 302a is turned off, simply discharging may be enabled through the diode 302b. Further, the charge control switch 302a may be so controlled by the processor 310 that when a large current flows upon charging, the charge control switch 302a is turned off to thereby block the charge current flowing through the current path of the assembled battery 301. The discharge control switch 303a may be so controlled by the processor 310 that when the battery voltage reaches an overdischarge detection voltage, the discharge control switch 303a is turned off to thereby prevent the discharge current from flowing through the current path of the assembled battery 301. After the discharge control switch 303a is turned off, simply charging may be enabled through the diode 303b. Further, the discharge control switch 303a may be so controlled by the processor 310 that when a large current flows upon discharging, the discharge control switch 303a is turned off to thereby block the discharge current flowing through the current path of the assembled battery 301.

The temperature detection device 308 may be, for example but not limited to, a thermistor. The temperature detection device 308 may be provided in the vicinity of the assembled battery 301. The temperature detection device 308 may measure a temperature of the assembled battery 301 and may supply data regarding the measured temperature to the processor 310. A voltage detector 311 may measure a voltage of the assembled battery 301 and a voltage of each of the secondary batteries 301a included therein, may perform A/D conversion on the measured voltages, and may supply data regarding the converted voltages to the processor 310. A current measurer 313 may measure a current by the current detection resistor 307 and may supply data regarding the measured current to the processor 310. A switch control processor 314 may control the charge control switch 302a and the discharge control switch 303a of the switcher 304, based on the data regarding the voltages supplied from the voltage detector 311 and the data regarding the current supplied from the current measurer 313.

When a voltage of any of the secondary batteries 301a reaches the overcharge detection voltage or below, or reaches the overdischarge detection voltage or below, or when a large current flows suddenly, the switch control processor 314 may transmit a control signal to the switcher 304 to thereby prevent overcharging and overdischarging, and overcurrent charging and discharging. For example, when the secondary battery is a lithium-ion secondary battery, the overcharge detection voltage may be determined to be, for example, 4.20 V±0.05 V, and the overdischarge detection voltage may be determined to be, for example, 2.4 V±0.1 V.

As the charge control switch 302a and the discharge control switch 303a, for example, semiconductor switches such as metal-oxide-semiconductor field-effect transistors (MOSFETs) may be used. In this case, parasitic diodes of the MOSFETs may serve as the diodes 302b and 303b. When P-channel FETs are used as the charge control switch 302a and the discharge control switch 303a, the switch control processor 314 may supply control signals CO and DO to a gate of the charge control switch 302a and a gate of the discharge control switch 303a, respectively. When the charge control switch 302a and the discharge control switch 303a are of a P-channel type, the charge control switch 302a and the discharge control switch 303a may each be turned on by a gate potential that is lower than a source potential by a predetermined value or more. For example, in normal charging and discharging operations, the control signals CO and DO may be set to a low level to turn on the charge control switch 302a and the discharge control switch 303a.

For example, upon overcharging or overdischarging, the control signals CO and DO may be set to a high level to turn off the charge control switch 302a and the discharge control switch 303a.

A memory 317 may include, for example, a random-access memory (RAM) and a read only memory (ROM). For example, the memory 317 may include a nonvolatile memory such as an erasable programmable read only memory (EPROM). In the memory 317, values including, without limitation, numerical values calculated by the processor 310 and a battery's internal resistance value of each of the secondary batteries 301a in an initial state measured in the manufacturing process stage, may be stored in advance and may be rewritable on an as-needed basis. Further, storing data regarding a full charge capacity of the secondary battery 301a in the memory 317 may allow the processor 310 to calculate, for example, a remaining capacity.

A temperature detector 318 may measure a temperature with use of the temperature detection device 308, may perform charge and discharge control upon abnormal heat generation, and may perform correction in calculating the remaining capacity.

The above-described secondary battery 1 according to an example embodiment of the present disclosure is mountable on, or usable to supply electric power to, for example, any of equipment including, without limitation, electronic equipment, an electric vehicle, an electric aircraft, and a power storage apparatus.

Non-limiting examples of the electronic equipment may include laptop personal computers, smartphones, tablet terminals, personal digital assistants (PDAs) as mobile information terminals, mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, traffic lights, and any other electronic equipment to which any embodiment of the present disclosure is applicable.

Non-limiting examples of the electric vehicle may include railway vehicles, golf carts, electric carts, electric automobiles including hybrid electric automobiles, and any other electric vehicle to which any embodiment of the present disclosure is applicable. The secondary battery 1 may be used as a driving power source or an auxiliary power source for any of these electric vehicles. Non-limiting examples of the power storage apparatuses may include a power storage power source for architectural structures including residential houses, or for power generation facilities, and any other power storage apparatus to which any embodiment of the present disclosure is applicable.

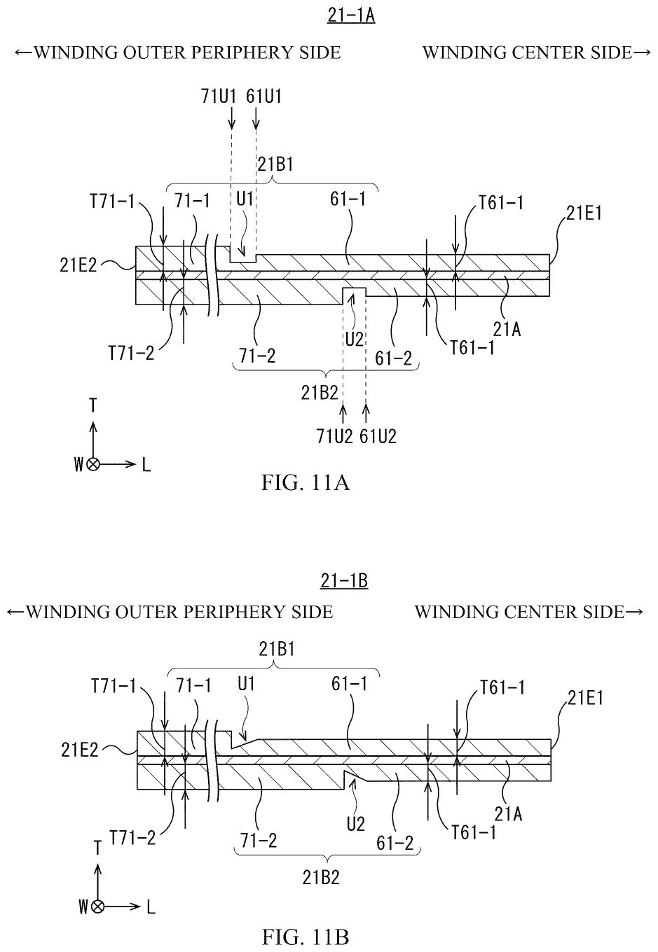

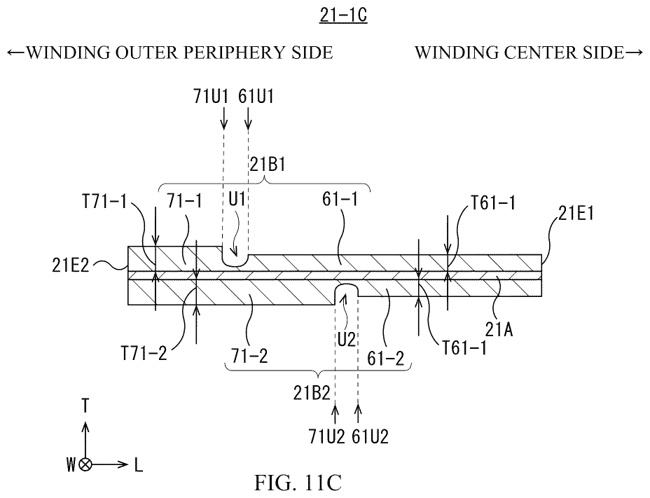

Next, a description is given of a positive electrode 21-1, i.e., each of positive electrodes 21-1A to 21-1C, according to a first modification example. The positive electrode 21-1, i.e., each of the positive electrodes 21-1A to 21-1C, may be applied to the secondary battery 1 according to the example embodiment described above. FIGS. 11A to 11C respectively illustrate sectional configurations of the positive electrodes 21-1A to 21-1C and each correspond to FIG. 6 illustrating the positive electrode 21 according to the example embodiment described above.

As illustrated in FIGS. 11A to 11C, in each of the positive electrodes 21-1A to 21-1C according to the first modification example, the inner winding side positive electrode active material layer 21B1 may further include a grooved part U1, and the outer winding side positive electrode active material layer 21B2 may further include a grooved part U2. The grooved part U1 may be positioned between the thick part 71-1 and the thin part 61-1. The grooved part U2 may be positioned between the thick part 71-2 and the thin part 61-2. The grooved parts U1 and U2 may each extend in the W direction. The grooved part U1 may have a thickness still smaller than the thickness T61-1 of the thin part 61-1 in the inner winding side positive electrode active material layer 21B1. Similarly, the grooved part U2 may have a thickness still smaller than the thickness T61-2 of the thin part 61-2 in the outer winding side positive electrode active material layer 21B2. Note that the grooved parts U1 and U2 of the positive electrode 21-1A in FIG. 11A may each have a sectional shape that is substantially rectangular. The grooved parts U1 and U2 of the positive electrode 21-1B in FIG. 11B may each have a sectional shape that is substantially V shaped. The grooved parts U1 and U2 of the positive electrode 21-1C in FIG. 11C may each have a sectional shape that is substantially U shaped. However, the sectional shape of each of the grooved parts U1 and U2 is not limited to that illustrated in each of FIGS. 11A to 11C, and may be chosen as desired.

In some embodiments, a width of the grooved part U1 and a width of the grooved part U2 in each of the positive electrodes 21-1A to 21-1C may be equal to each other in the L direction. In some embodiments, the width of the grooved part U1 and the width of the grooved part U2 in each of the positive electrodes 21-1A to 21-1C may be different from each other in the L direction. The width of the grooved part U1 may refer to a length in the L direction from a position of a border 71U1 between the thick part 71-1 and the grooved part U1 to a position of a border 61U1 between the thin part 61-1 and the grooved part U1. The width of the grooved part U2 may refer to a length in the L direction from a position of a border 71U2 between the thick part 71-2 and the grooved part U2 to a position of a border 61U2 between the thin part 61-2 and the grooved part U2. Each of the width of the grooved part U1 and the width of the grooved part U2 may be about 150 μm, for example.

In each of the configuration examples of the positive electrodes 21-1A to 21-1C respectively illustrated in FIGS. 11A to 11C, the position of the border 71U1 in the L direction and the position of the border 71U2 in the L direction may be different from each other, and also the position of the border 61U1 in the L direction and the position of the border 61U2 in the L direction may be different from each other. However, in some embodiments, the position of the border 71U1 in the L direction and the position of the border 71U2 in the L direction may coincide with each other. In some embodiments, the position of the border 61U1 in the L direction and the position of the border 61U2 in the L direction may coincide with each other. In some embodiments, the position of the border 71U1 in the L direction and the position of the border 71U2 in the L direction may coincide with each other, and additionally, the position of the border 61U1 in the L direction and the position of the border 61U2 in the L direction may coincide with each other.

In each of the configuration examples of the positive electrodes 21-1A to 21-1C respectively illustrated in FIGS. 11A to 11C, the inner winding side positive electrode active material layer 21B1 may include the grooved part U1, and the outer winding side positive electrode active material layer 21B2 may include the grooved part U2. However, in some embodiments, either the grooved part U1 or the grooved part U2 may be simply provided. In some embodiments, each of the positive electrodes 21-1A to 21-1C may simply include either the inner winding side positive electrode active material layer 21B1 or the outer winding side positive electrode active material layer 21B2.

As described above, each of the positive electrodes 21-1A to 21-1C according to the first modification example may have the grooved part U1, the grooved part U2, or both. When the secondary battery 1 includes any of the positive electrodes 21-1A to 21-1C, this helps to allow the separator 23 to be held more firmly between corresponding one of the positive electrodes 21-1A to 21-1C and the negative electrode 22. One reason for this is that the separator 23 being partly disposed in the grooved part U1, the grooved part U2, or both helps to prevent the separator 23 interposed between the corresponding one of the positive electrodes 21-1A to 21-1C and the negative electrode 22 from being easily displaced or detached from a predetermined position. As a result, the secondary battery 1 including any of the positive electrodes 21-1A to 21-1C helps to effectively prevent a short circuit between the corresponding one of the positive electrodes 21-1A to 21-1C and the negative electrode 22. This helps to achieve even superior reliability.

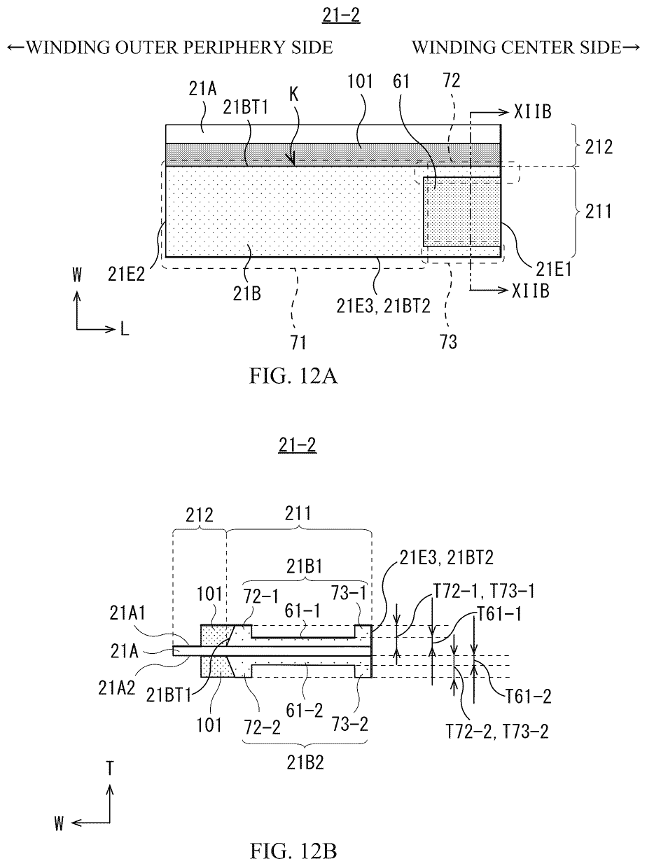

Next, referring to FIGS. 12A and 12B, a description is given of a positive electrode 21-2 according to a second modification example. The positive electrode 21-2 may be applied to the secondary battery 1 according to the example embodiment described above. FIG. 12A is a developed view of the positive electrode 21-2 and corresponds to FIG. 4A illustrating the positive electrode 21 according to the example embodiment described above. FIG. 12B is a sectional view of the positive electrode 21-2 and corresponds to FIG. 4B illustrating the positive electrode 21 according to the example embodiment described above. Note that FIG. 12B illustrates a section as viewed in an arrowed direction along line XIIB-XIIB illustrated in FIG. 12A.

As illustrated in FIGS. 12A and 12B, the positive electrode active material layer 21B of the positive electrode 21-2 may further include thick parts 72 and 73 in addition to the thin part 61 and the thick part 71. Except for the above-described points, the positive electrode 21-2 may have a configuration similar to the configuration of the positive electrode 21 according to the example embodiment described above. In the positive electrode 21-2, each of the thin part 61 and the thick parts 71 to 73 may be provided on each of the inward positive electrode current collector surface 21A1 and the outward positive electrode current collector surface 21A2. In other words, each of the inner winding side positive electrode active material layer 21B1 and the outer winding side positive electrode active material layer 21B2 may include the thin part 61 and the thick parts 71 to 73. It may suffice, however, that in the positive electrode 21-2, at least either the inner winding side positive electrode active material layer 21B1 or the outer winding side positive electrode active material layer 21B2 includes the thin part 61 and the thick parts 71 to 73. Note that, for convenience, in FIG. 12B, the thin part 61 and the thick parts 71, 72, and 73 included in the inner winding side positive electrode active material layer 21B1 are respectively denoted as the thin part 61-1 and thick parts 71-1, 72-1, and 73-1. The thin part 61 and the thick parts 71, 72, and 73 included in the outer winding side positive electrode active material layer 21B2 are respectively denoted as the thin part 61-2 and thick parts 71-2, 72-2, and 73-2. In some embodiments, in the example illustrated in FIG. 12B, the position of the border 21BIK between the thin part 61-1 and the thick part 71-1 in the L direction may substantially coincide with the position of the border 21B2K between the thin part 61-2 and the thick part 71-2 in the L direction. In some embodiments, the position of the border 21BIK in the L direction may be different from the position of the border 21B2K in the L direction.

Each of the thick parts 71 to 73 may have a thickness greater than a thickness of the thin part 61. For example, the thickness of the thin part 61 may be about half the thickness of each of the thick parts 71 to 73. In some embodiments, the respective thicknesses of the thick parts 71 to 73 may be equal to each other. In some embodiments, the respective thicknesses of the thick parts 71 to 73 may be different from each other. For example, as illustrated in FIG. 12B, in the inner winding side positive electrode active material layer 21B1, each of a thickness T72-1 of the thick part 72-1 and a thickness T73-1 of the thick part 73-1 may be greater than the thickness T61-1 of the thin part 61-1. Similarly, in the outer winding side positive electrode active material layer 21B2, each of a thickness T72-2 of the thick part 72-2 and a thickness T73-2 of the thick part 73-2 may be greater than the thickness T61-2 of the thin part 61-2. In some embodiments, the thickness T71-1 (refer to FIG. 4C), the thickness T72-1, and the thickness T73-1 may be equal to the thickness T71-2 (refer to FIG. 4C), the thickness T72-2, and the thickness T73-2, respectively. In some embodiments, the thickness T71-1, the thickness T72-1, and the thickness T73-1 may be different from the thickness T71-2, the thickness T72-2, and the thickness T73-2, respectively. In addition, a length of the thick part 71 may be greater than a length of each of the thick parts 72 and 73 in the width direction of the positive electrode 21-2.

The thick part 72 may be adjacent to the thin part 61 in the W direction. For example, the thick part 72 may be positioned between the thin part 61 and the insulating layer 101 in the W direction. In some embodiments, the thick part 71 may include the first end face 21BT1 and may be in contact with the insulating layer 101. The thick part 73 may include a second end face 21BT2 positioned on an opposite side to the first end face 21BT1 in the W direction. In some embodiments, the thick parts 71 to 73 may be separated from each other. In some embodiments, the thick parts 71 to 73 may be partly or entirely integrated with each other. Each of the thick parts 72 and 73 may include the winding center side edge 21E1 of the positive electrode 21-2 in the L direction.

As described above, in the positive electrode 21-2 according to the second modification example, the positive electrode active material layer 21B may include the thick part 72 and the thick part 73 with the thin part 61 interposed therebetween in the W direction. This helps to allow the separator 23, which is disposed between the positive electrode active material layer 21B and the negative electrode active material layer 22B, to be firmly held. This helps to prevent easy occurrence of winding displacement of the electrode wound body 20 upon expansion and contraction of the electrode wound body 20, and thus helps to prevent the separator 23 from being displaced from a predetermined position. The prevention of the displacement helps to prevent a short circuit between the positive electrode 21-2 and the negative electrode 22. For example, the secondary battery 1 including the positive electrode 21-2 instead of the positive electrode 21 helps to achieve superior reliability.

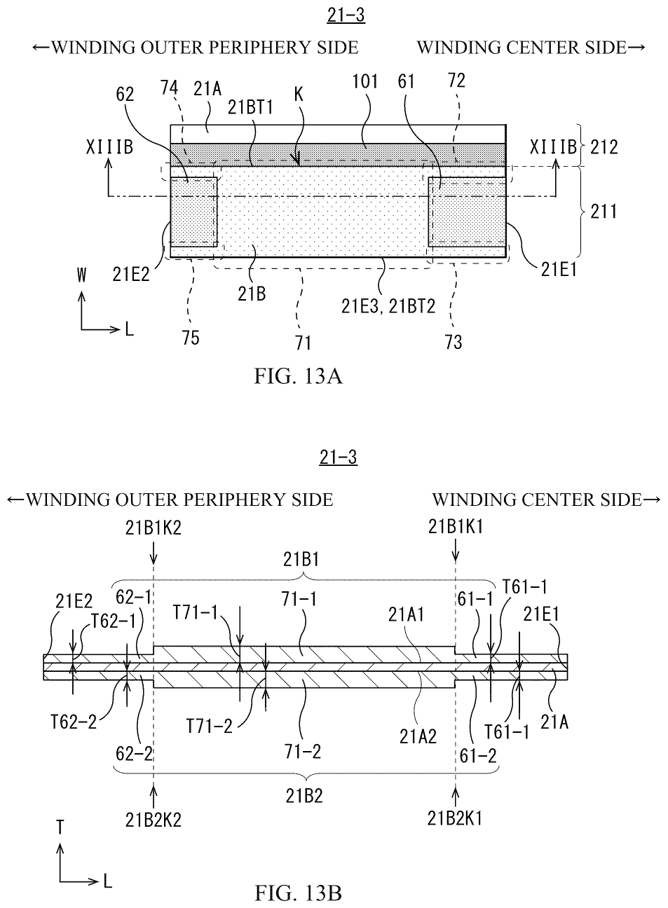

Next, referring to FIGS. 13A and 13B, a description is given of a positive electrode 21-3 according to a third modification example. The positive electrode 21-3 may be applied to the secondary battery 1 according to the example embodiment described above. FIG. 13A is a developed view of the positive electrode 21-3 and corresponds to FIG. 4A illustrating the positive electrode 21 according to the example embodiment described above. FIG. 13B is a sectional view of the positive electrode 21-3 and corresponds to FIG. 4C illustrating the positive electrode 21 according to the example embodiment described above. Note that FIG. 13B illustrates a section as viewed in an arrowed direction along line XIIIB-XIIIB illustrated in FIG. 13A.

As illustrated in FIGS. 13A and 13B, in the positive electrode 21-3, the positive electrode active material layer 21B may further include a thin part 62. The thin part 62 may be provided on an opposite side of the thick part 71 to the thin part 61. The thin part 62 may have a thickness smaller than the thickness of the thick part 71. The thin part 62 may include the winding outer periphery side edge 21E2 of the positive electrode 21-3 in the L direction. In some embodiments, the thin part 62 may have a length in the L direction that corresponds to, for example, about a half wind or less of the electrode wound body 20 from the winding outer periphery side edge 21E2. The positive electrode active material layer 21B may further include a thick part 74 adjacent to the thin part 62 in the W direction. For example, the thick part 74 may be positioned between the thin part 62 and the insulating layer 101 in the W direction. In some embodiments, the thick part 74 may include the first end face 21BT1 and may be in contact with the insulating layer 101. The positive electrode active material layer 21B may further include a thick part 75. The thick part 75 may include the second end face 21BT2.

In the positive electrode 21-3 according to the third modification example, the thin part 62 may be provided on each of the inward positive electrode current collector surface 21A1 and the outward positive electrode current collector surface 21A2. In other words, each of the inner winding side positive electrode active material layer 21B1 and the outer winding side positive electrode active material layer 21B2 may include the thin part 62. In some embodiments, however, in the positive electrode 21-3, it may suffice that at least either the inner winding side positive electrode active material layer 21B1 or the outer winding side positive electrode active material layer 21B2 includes the thin part 62. Note that, for convenience, in FIG. 13B, the thin part 62 included in the inner winding side positive electrode active material layer 21B1 is denoted as a thin part 62-1, and the thin part 62 included in the outer winding side positive electrode active material layer 21B2 is denoted as a thin part 62-2. Further, in the modification example illustrated in FIG. 13B, a position of a border 21B1K1 between the thin part 61-1 and the thick part 71-1 in the L direction may substantially coincide with a position of a border 21B2K1 between the thin part 61-2 and the thick part 71-2 in the L direction. Further, in the modification example illustrated in FIG. 13B, a position of a border 21B1K2 between the thin part 62-1 and the thick part 71-1 in the L direction may substantially coincide with a position of a border 21B2K2 between the thin part 62-2 and the thick part 71-2 in the L direction.

As described above, the positive electrode 21-3 according to the third modification example may include, in addition to the thin part 61, the thin part 62 provided on the winding outer periphery side of the electrode wound body 20. This helps to further improve the softness of the positive electrode 21. Furthermore, providing the thin part 62 makes it possible to reduce, on the winding outer periphery side of the electrode wound body 20, a level difference between a region where the positive electrode 21 is present and a region where no positive electrode 21 is present, as compared with when the positive electrode 21 with no thin part 62 is used. This helps to reduce concentration of stress at a location, of the separator 23, that overlaps the winding outer periphery side edge 21E2. Reducing the concentration of stress helps to avoid breakage of the separator 23 even when the separator 23 has a reduced thickness, and to thereby prevent a short circuit between the positive electrode 21 and the negative electrode 22. In other words, it helps to allow for reduction in the thickness of the separator 23. The reduction in the thickness of the separator 23 allows a spacing between the positive electrode 21 and the negative electrode 22 to be reduced, which decreases the internal resistance of the electrode wound body 20. This helps to improve the rate characteristic at the time of charging and discharging and to increase the capacity of the secondary battery 1.

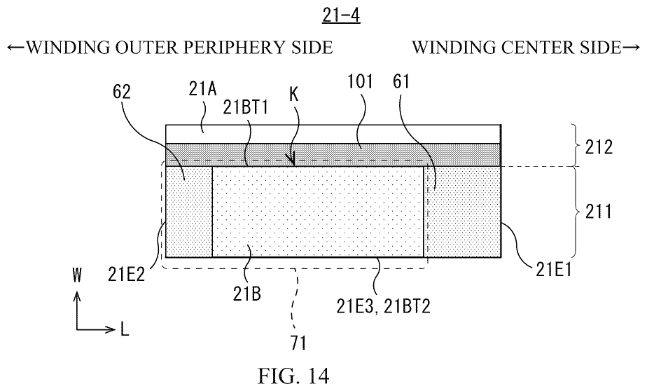

FIG. 14 is a developed view of a positive electrode 21-4 according to a fourth modification example and corresponds to FIG. 4A illustrating the positive electrode 21 according to the example embodiment described above. The positive electrode 21-4 may be applied to the secondary battery 1 according to the example embodiment described above. In the positive electrode 21-4 according to the fourth modification example, the positive electrode active material layer 21B may further include the thin part 62 similarly to the positive electrode 21-3 according to the third modification example described above. The thin part 62 may be provided on an opposite side of the thick part 71 to the thin part 61 and may include the winding outer periphery side edge 21E2. Note that in the positive electrode 21-4, the positive electrode active material layer 21B may include no thick parts 72 to 75, and the thin parts 61 and 62 may each extend from the first end face 21BT1 of the positive electrode active material layer 21B to the second end face 21BT2 of the positive electrode active material layer 21B in the W direction. Except for the above-described points, the positive electrode 21-4 may have a configuration similar to the configuration of the positive electrode 21-3. As a result, the positive electrode 21-4 according to the fourth modification example may achieve action and example effects that are similar to those of the above-described positive electrode 21-3 achieved by providing the thin part 62.

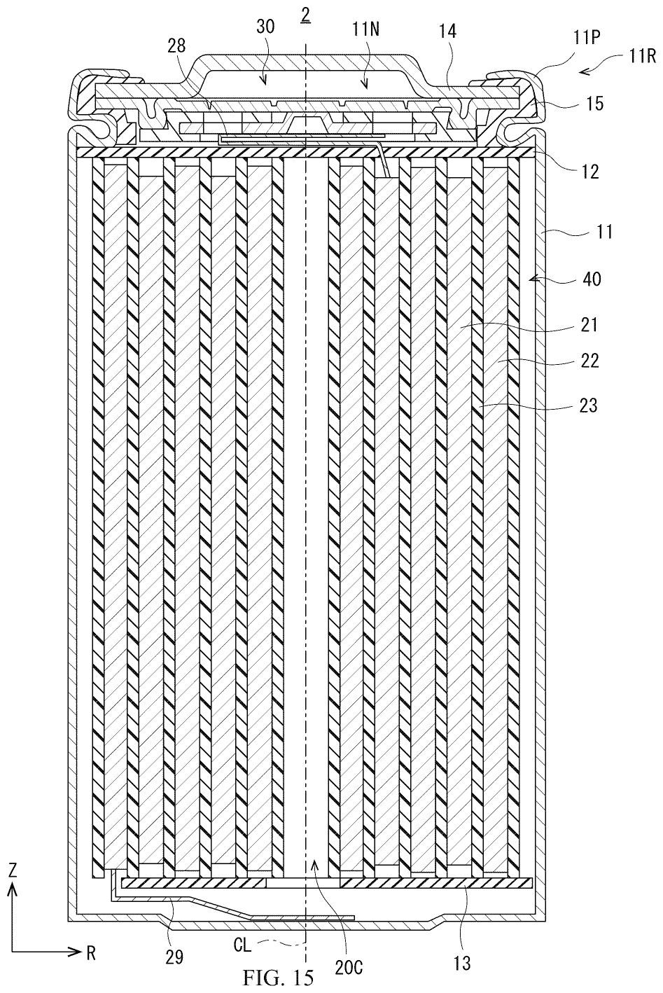

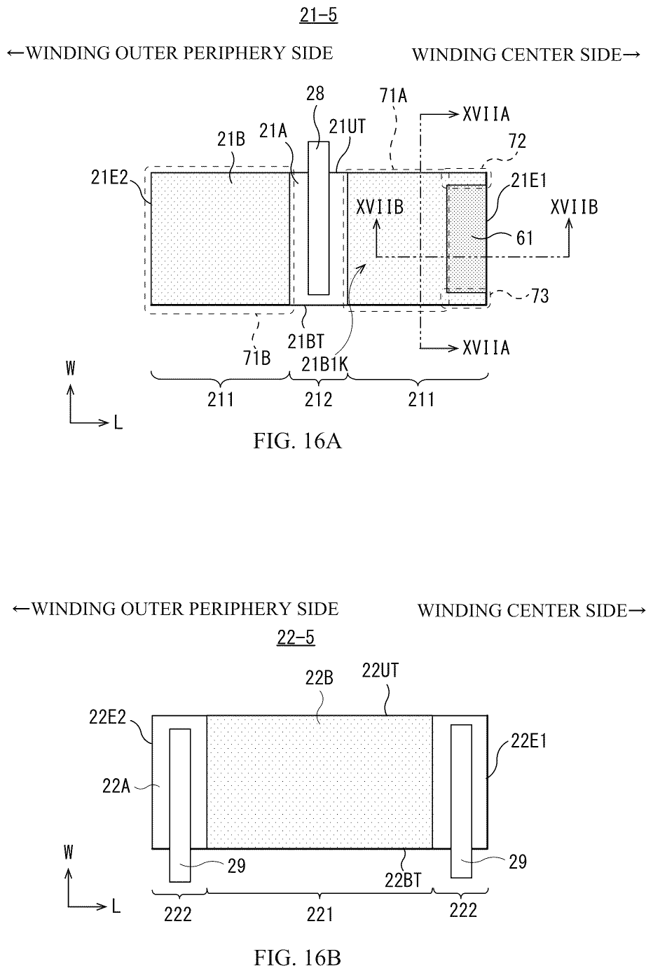

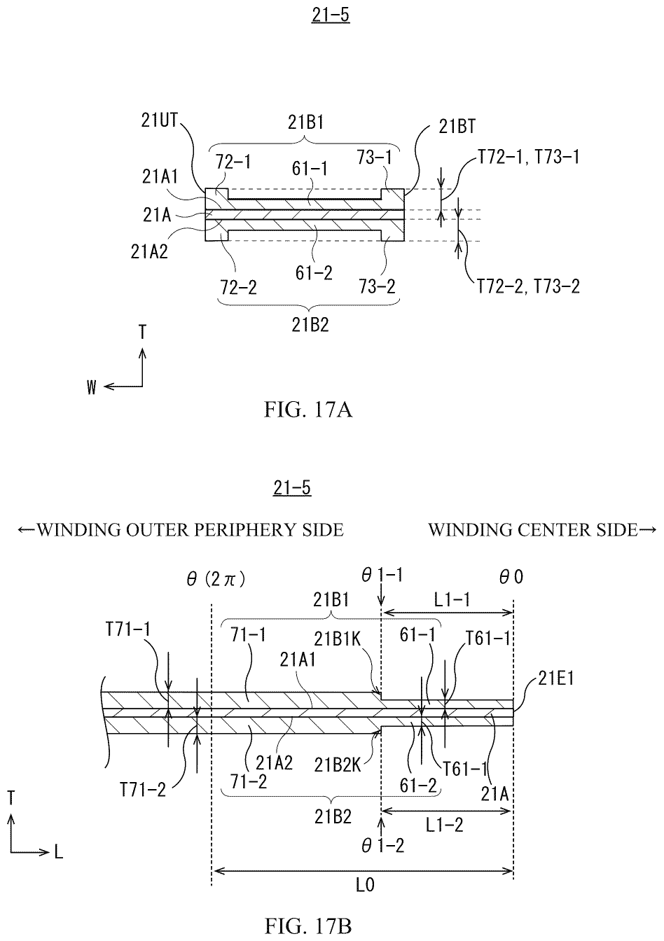

The description above of the example embodiment refers to the example where the secondary battery 1 includes the positive electrode 21 and the negative electrode 22 of what is called a tabless structure; however, an embodiment of the present disclosure is not limited thereto. In some embodiments, the secondary battery according to an embodiment of the present disclosure may include, for example, a secondary battery 2 illustrated in FIG. 15. The secondary battery 2 according to a fifth modification example of the example embodiment of the present disclosure may include a positive electrode 21-5 and a negative electrode 22-5. The positive electrode 21-5 may have a tab structure including a positive electrode lead 28 illustrated in FIG. 16A. The negative electrode 22-5 may have a tab structure including a negative electrode lead 29 illustrated in FIG. 16B. FIG. 16A is a developed view of the positive electrode 21-5 and corresponds to FIG. 4A illustrating the positive electrode 21 according to the example embodiment described above. FIG. 16B is a developed view of the negative electrode 22-5 and corresponds to FIG. 7A illustrating the negative electrode 22 according to the example embodiment described above. FIGS. 17A and 17B each illustrate a sectional configuration of the positive electrode 21-5. FIG. 17A illustrates a section as viewed in an arrowed direction along line XVIIA-XVIIA illustrated in FIG. 16A. FIG. 17B illustrates a section as viewed in an arrowed direction along line XVIIB-XVIIB illustrated in FIG. 16A.

As illustrated in FIG. 15, the secondary battery 2 may include an electrode wound body 40 contained in the outer package can 11. The secondary battery 2 may further include the insulating plates 12 and 13, the battery cover 14, the gasket 15, and the safety valve mechanism 30. The electrode wound body 40 of the secondary battery 2 may include a stacked body in a wound state. The stacked body may include the positive electrode 21-5 and the negative electrode 22-5 that are stacked with the separator 23 interposed therebetween.

The positive electrode 21-5 may include, as illustrated in FIG. 16A, the positive electrode current collector 21A and the positive electrode active material layer 21B. The positive electrode active material layer 21B may cover a part of the surface of the positive electrode current collector 21A. The positive electrode covered region 211 and the positive electrode exposed region 212 may each extend from an upper edge 21UT of the positive electrode 21-5 to a lower edge 21BT of the positive electrode 21-5, along the W direction, i.e., a transverse direction of the positive electrode 21-5, as illustrated in FIG. 16A. For example, one positive electrode exposed region 212 may be provided at a middle part of the positive electrode 21-5 in the L direction, i.e., a longitudinal direction of the positive electrode 21-5. For example, the positive electrode 21-5 may include two positive electrode covered regions 211 separated from each other in the L direction by the positive electrode exposed region 212. The positive electrode lead 28 may be attached to the positive electrode current collector 21A in the positive electrode exposed region 212. The positive electrode active material layer 21B may include the thin part 61 and the thick parts 71 to 73. The thin part 61 of the positive electrode active material layer 21B may include the winding center side edge 21E1 of the innermost wind part of the positive electrode 21-5. Note that in FIG. 16A, the thick part 71 in the positive electrode covered region 211 positioned on the winding center side, out of the two positive electrode covered regions 211, is denoted with a reference numeral 71A, and the thick part 71 in the positive electrode covered region 211 positioned on the winding outer periphery side, out of the two positive electrode covered regions 211, is denoted with a reference numeral 71B.

The negative electrode 22-5 may include, as illustrated in FIG. 16B, the negative electrode current collector 22A and the negative electrode active material layer 22B. The negative electrode active material layer 22B may be provided on each of the two opposite surfaces of the negative electrode current collector 22A, for example. The negative electrode 22-5 may include the negative electrode covered region 221 and two negative electrode exposed regions 222. As illustrated in FIG. 16B, the two negative electrode exposed regions 222 may be provided at two respective opposite ends in the L direction of the negative electrode 22-5. For example, one of the two negative electrode exposed regions 222 may include the winding center side edge 22E1 of the innermost wind part of the negative electrode 22-5, and another of the two negative electrode exposed regions 222 may include the winding outer periphery side edge 22E2 of the outermost wind part of the negative electrode 22-5. The negative electrode covered region 221 may be interposed between the two negative electrode exposed regions 222 in the L direction. The negative electrode lead 29 may be attached to the negative electrode current collector 22A in each of the two negative electrode exposed regions 222. The negative electrode lead 29 may be so provided that a part of the negative electrode lead 29 protrudes downward from a lower edge 22BT of the negative electrode 22-5.

The positive electrode active material layer 21B may include the thin part 61 and the thick parts 71 to 73. The thick part 71 may be provided at each of two locations that are positioned with the positive electrode exposed region 212 interposed therebetween. In FIG. 16A, such thick parts 71 are denoted with the respective reference numerals 71A and 71B. In the positive electrode 21-5, the thin part 61 and the thick parts 71 to 73 may be provided on each of the inward positive electrode current collector surface 21A1 and the outward positive electrode current collector surface 21A2. In other words, each of the inner winding side positive electrode active material layer 21B1 and the outer winding side positive electrode active material layer 21B2 may include the thin part 61 and the thick parts 71 to 73. Note that, for convenience, in FIGS. 17A and 17B, the thin part 61 and the thick parts 71, 72, and 73 included in the inner winding side positive electrode active material layer 21B1 are respectively denoted as the thin part 61-1 and the thick parts 71-1, 72-1, and 73-1. The thin part 61 and the thick parts 71, 72, and 73 included in the outer winding side positive electrode active material layer 21B2 are respectively denoted as the thin part 61-2 and the thick parts 71-2, 72-2, and 73-2 for convenience. Further, in the example illustrated in FIG. 17B, the position of the border 21BIK between the thin part 61-1 and the thick part 71-1 in the L direction may coincide with the position of the border 21B2K between the thin part 61-2 and the thick part 71-2 in the L direction. In some embodiments, the position of the border 21B1K between the thin part 61-1 and the thick part 71-1 in the L direction and the position of the border 21B2K between the thin part 61-2 and the thick part 71-2 in the L direction may be different from each other.

The thin part 61 may include the winding center side edge 21E1 of the positive electrode active material layer 21B in the L direction. In some embodiments, the thin part 61 may extend in the L direction from the winding center side edge 21E1 within a range corresponding to about one wind to about five winds of the electrode wound body 40. The thick part 71 may be provided on an opposite side of the thin part 61 to the winding center side edge 21E1 in the L direction. The thick part 72 may be adjacent to the thin part 61 in the W direction. For example, the thick part 72 may be positioned between the thin part 61 and the upper edge 21UT in the W direction. The thick part 72 may include the upper edge 21UT. The thick part 73 may be positioned on an opposite side of the thin part 61 to the thick part 72 in the W direction. In other words, the thick part 73 may be positioned between the lower edge 21BT and the thin part 61. The lower edge 21BT may be positioned on the opposite side to the upper edge 21UT in the W direction. The thick part 73 may include the lower edge 21BT. In some embodiments, the thick parts 71 to 73 may be separated from each other. In some embodiments, the thick parts 71 to 73 may be partly or entirely integrated with each other.

In the secondary battery 2 according to the fifth modification example including the positive electrode 21-5 also, the position of the border 21BIK between the thin part 61-1 and the thick part 71-1 and the position of the border 21B2K between the thin part 61-2 and the thick part 71-2 may each be different from the position overlapping the position of the winding center side edge 21E1 of the positive electrode 21 in the radial direction of the electrode wound body 40. For example, as illustrated in FIG. 17B, each of the lengths L1-1 and L1-2 may each be smaller than the length L0. Accordingly, effects similar to those of the above-described example embodiment are expected also in the secondary battery 2 according to the fifth modification example.

### EXAMPLES

A description is given of Examples of an example embodiment of the present disclosure.

### Examples 1 to 17

### [Fabrication of Secondary Battery]

The secondary battery 2 of the cylindrical type illustrated in FIG. 15 (having a diameter, i.e., an outer diameter, of 18 mm, and a length of 65 mm) was fabricated in accordance with the following procedure.

### [Fabrication of Positive Electrode]

First, 94 parts by mass of the positive electrode active material (LiNi_{0.5}Co_{0.2}Mn_{0.3}O₂), 3 parts by mass of the positive electrode binder (polyvinylidene difluoride), and 3 parts by mass of the positive electrode conductor (graphite) were mixed with each other to thereby obtain a positive electrode mixture. Thereafter, the positive electrode mixture was put into a solvent (N-methyl-2-pyrrolidone as an organic solvent), following which the organic solvent was stirred to thereby prepare a positive electrode mixture slurry in paste form. Thereafter, the positive electrode mixture slurry was applied, using a coating apparatus, on the two opposite surfaces of the positive electrode current collector 21A (a band-shaped aluminum foil having a thickness of 12 μm), following which the applied positive electrode mixture slurry was dried to thereby form the inner winding side positive electrode active material layer 21B1 and the outer winding side positive electrode active material layer 21B2. Thereafter, the inner winding side positive electrode active material layer 21B1 and the outer winding side positive electrode active material layer 21B2 were compression-molded using a roll pressing machine. Further, a predetermined region of each of the inner winding side positive electrode active material layer 21B1 and the outer winding side positive electrode active material layer 21B2 was partially removed by laser ablation to thereby form the thin part 61. At this time, as illustrated in FIGS. 16A and 17A, parts of each of the inner winding side positive electrode active material layer 21B1 and the outer winding side positive electrode active material layer 21B2 were left unremoved to thereby form the thick part 71 (i.e., each of the thick parts 71A and 71B) and the thick parts 72 and 73. Note that in Example 1, the width of each of the thick parts 72 and 73 in the W direction was set to 6 mm, which corresponded to 10% of the entire width of the positive electrode covered region 211 in the W direction, i.e., 60 mm. In Example 1, positions, dimensions, and shapes of the thin part 61-1 and the thick parts 71-1 to 73-1 of the inner winding side positive electrode active material layer 21B1 were substantially the same as positions, dimensions, and shapes of the thin part 61-2 and the thick parts 71-2 to 73-2 of the outer winding side positive electrode active material layer 21B2, respectively. A length of the positive electrode 21 in the L direction was set to 1400 mm. Here, the length of the thin part 61 in the L direction, i.e., each of the length L1 (L1-1) from the winding center side edge 21E1 to the border 21B1K and the length L1 (L1-2) from the winding center side edge 21E1 to the border 21B2K, was set to have a predetermined ratio to the length L0 of the innermost wind part of the positive electrode 21. The positive electrode active material layer 21B including the thin part 61 and the thick parts 71 to 73 was thus formed on each of the two opposite surfaces of the positive electrode current collector 21A. Thereafter, the positive electrode lead 28 including aluminum was welded to the positive electrode current collector 21A in the positive electrode exposed region 212 to obtain the positive electrode 21.

### [Fabrication of Negative Electrode]

First, 95 parts by mass of the negative electrode active material (graphite), 3 parts by mass of the negative electrode binder (a styrene-butadiene rubber (SBR)), and 2 parts by mass of the negative electrode conductor (carbon black) were mixed with each other to thereby obtain a negative electrode mixture. Thereafter, the negative electrode mixture was put into a solvent (water), following which the mixture including the solvent and the negative electrode mixture was stirred to thereby prepare a negative electrode mixture slurry in paste form. Thereafter, the negative electrode mixture slurry was selectively applied, using a coating apparatus on the negative electrode covered region 221 on each of the two opposite surfaces of the negative electrode current collector 22A (a band-shaped copper foil having a thickness of 12 μm), following which the applied negative electrode mixture slurry was dried to thereby form the negative electrode active material layer 22B. In addition, the negative electrode active material layers 22B were compression-molded using a roll pressing machine. Thereafter, the negative electrode lead 29 including nickel was welded to the negative electrode current collector 22A of each of the two negative electrode exposed regions 222 to obtain the negative electrode 22.

### [Preparation of Electrolytic Solution]

The electrolyte salt (LiPF₆) was added to the solvent (ethylene carbonate, ethyl methyl carbonate, and dimethyl carbonate), following which the solvent was stirred. In this case, a mixture ratio (a weight ratio) between ethylene carbonate, ethyl methyl carbonate, and dimethyl carbonate in the solvent was set to 20:20:60, and the content of the electrolyte salt was set to 1 mol/kg with respect to the solvent.

### [Assembly of Secondary Battery]

First, the positive electrode 21 and the negative electrode 22 were stacked on each other with the separator 23 (a porous polyethylene film having a thickness of 8 μm) interposed therebetween, following which the positive electrode 21, the negative electrode 22, and the separator 23 were wound to thereby fabricate the electrode wound body 40 having a through hole 20C. Upon fabricating the electrode wound body 40, the positive electrode 21 and the negative electrode 22 were so aligned with each other that an entire region in which the negative electrode lead 29 and the negative electrode current collector 22A overlapped each other in a stacking direction of the positive electrode 21 and the negative electrode 22, i.e., all of the overlapping region, overlapped a protective tape in the stacking direction.

Thereafter, the electrode wound body 40 was placed, together with the pair of insulating plates 12 and 13, inside the outer package can 11 that included iron and was nickel-plated. The positive electrode lead 28 was welded to the safety valve mechanism 30, and the negative electrode lead 29 was welded to the outer package can 11. Thereafter, the electrolytic solution was injected into the outer package can 11 by a reduced-pressure method to thereby cause the electrode wound body 40 to be impregnated with the electrolytic solution.

Thereafter, asphalt was added to a solvent (ethylcyclohexane as an organic solvent), following which the solvent was stirred to thereby prepare a coating solution. Thereafter, the coating solution was applied to the gasket 15 including polypropylene.

Thereafter, the open end part 11N of the outer package can 11 and both the battery cover 14 and the safety valve mechanism 30 were crimped to each other with the gasket 15 including polypropylene interposed between the open end part 11N and both the battery cover 14 and the safety valve mechanism 30, to thereby form the crimped structure 11R.

The open end part 11N of the outer package can 11 was thus closed by the battery cover 14, and the electrode wound body 40 and other components were contained inside the outer package can 11. The secondary battery 2 of the cylindrical type was thus assembled.

### [Stabilization of Secondary Battery]

The secondary battery 2 was charged and discharged for one cycle in an ambient temperature environment (at a temperature of 23° C.). Upon charging, the secondary battery 2 was charged with a constant current of 0.1 C until a voltage reached 4.2 V, and was thereafter charged with a constant voltage of that value, 4.2 V, until a current reached 0.05 C. Upon discharging, the secondary battery 2 was discharged with a constant current of 0.1 C until the voltage reached 3.0 V. Note that 0.1 C was a value of a current that caused a battery capacity, i.e., a theoretical capacity, of 4000 mAh to be completely discharged in 10 hours, and 0.05 C was a value of a current that caused the battery capacity of 4000 mAh to be completely discharged in 20 hours.

The state of the secondary battery 2 was thus electrochemically stabilized.

### [Characteristic Evaluation of Secondary Battery]

### [Measurement of Lengths L0 and L1]

For the secondary battery 2 of each of Examples 1 to 17 obtained as described above, a CT image of a section orthogonal to the Z-axis was acquired, and the innermost one wind of the positive electrode 21 was approximated with a spline curve, based on the acquired CT image, to thereby determine the length L0 of the innermost wind part of the positive electrode 21. The length L0 of the innermost wind part of the positive electrode 21 was 12.88 mm. The length L1, i.e., each of the lengths L1-1 and L1-2, was measured by a similar procedure. The ratio L1/L0 is presented in Table 1.

### [Area Density Ratio]

For the secondary battery 2 of each of Examples 1 to 17 obtained as described above, an area density ratio of each of the inner winding side positive electrode active material layer 21B1 and the outer winding side positive electrode active material layer 21B2 was measured. Herein, the area density ratio referred to a ratio of an area density of the thin part 61 to an area density of the thick part 71. Specifically, the area density ratio was determined as follows. First, the secondary battery 2 that had been fabricated was discharged. Specifically, the secondary battery 2 was discharged with a constant current of 0.1 C in a temperature environment at 25±5° C., until a voltage reached an end-of-discharge voltage of 2 V. Note that 1 C was a value of a current that caused a total capacity of a battery to be completely discharged in 1 hour, and 0.1 C was a value of a current that was 0.1 times that value, i.e., a value of a current that caused the total capacity of the battery to be completely discharged in 5 hours. Thereafter, the secondary battery 2 after being discharged was disassembled to take out the positive electrode 21. The positive electrode 21 that had been taken out was washed with a solvent (e.g., diethyl carbonate) and was sufficiently dried. Thereafter, the inner winding side positive electrode active material layer 21B1 and the outer winding side positive electrode active material layer 21B2 were removed from the respective opposite surfaces of the positive electrode current collector 21A with use of a cloth soaked with a solvent (e.g., N-methyl-2-pyrrolidone). Thereafter, the solvent was removed from the surfaces of the positive electrode current collector 21A with use of a cloth soaked with ethanol, following which the surfaces of the positive electrode current collector 21A were sufficiently dried at a room temperature. The positive electrode current collector 21A alone with the inner winding side positive electrode active material layer 21B1 and the outer winding side positive electrode active material layer 21B2 being removed was thus obtained. Thereafter, a weight of a piece of the aluminum foil obtained by punching the positive electrode current collector 21A, using a punch having a diameter q of 3 mm, i.e., a positive electrode current collector mass Mm, was measured. An area density Dm of the positive electrode current collector 21A was determined by dividing the obtained positive electrode current collector mass Mm by an area A of the piece of the aluminum foil.

$${D}_{m} = M m / A$$

Further, the stacked body including the positive electrode current collector 21A and the inner winding side positive electrode active material layer 21B1 obtained by removing only the outer winding side positive electrode active material layer 21B2 from the positive electrode 21 by the above-described procedure was used, to punch out, using the punch having the diameter φ of 3 mm, each of a part of the thin part 61 of the inner winding side positive electrode active material layer 21B1 and a part of the thick part 71 of the inner winding side positive electrode active material layer 21B1 together with the positive electrode current collector 21A. A mass M_{1,A} of a sample punched out from the thin part 61 and a mass M_{2,A} of a sample punched out from the thick part 71 were each measured. An area density D_{1,A} of the thin part 61 of the inner winding side positive electrode active material layer 21B1 was obtained by subtracting the positive electrode current collector mass Mm from the mass M_{1,A}. An area density D_{2,A} of the thick part 71 of the inner winding side positive electrode active material layer 21B1 was obtained by subtracting the positive electrode current collector mass Mm from the mass M_{2,A}.

$$\begin{matrix}{D}_{1 , A} = ( {M}_{1 , A} - M m ) / A \\ {D}_{2 , A} = ( {M}_{2 , A} - M m ) / A\end{matrix}$$

Further, an area density ratio D_{1,A}/D_{2,A} was calculated. The results are presented in Table 1. Note that numerical values presented in Table 1 were each an average value of five measured values at five respective points.

Similarly, the stacked body including the positive electrode current collector 21A and the outer winding side positive electrode active material layer 21B2 obtained by removing only the inner winding side positive electrode active material layer 21B1 from the positive electrode 21 was used, to punch out, using the punch having the diameter φ of 3 mm, each of a part of the thin part 61 of the outer winding side positive electrode active material layer 21B2 and a part of the thick part 71 of the outer winding side positive electrode active material layer 21B2 together with the positive electrode current collector 21A. A mass M_{1,B} of a sample punched out from the thin part 61 and a mass M_{2,B} of a sample punched out from the thick part 71 were each measured. An area density D_{1,B} of the thin part 61 of the outer winding side positive electrode active material layer 21B2 was obtained by subtracting the positive electrode current collector mass Mm from the mass M_{1,B}. An area density D_{2,B} of the thick part 71 of the outer winding side positive electrode active material layer 21B2 was obtained by subtracting the positive electrode current collector mass Mm from the mass M_{2,B}.

$$\begin{matrix}{D}_{1 , B} = ( {M}_{1 , B} - M m ) / A \\ {D}_{2 , B} = ( {M}_{2 , B} - M m ) / A\end{matrix}$$

Further, an area density ratio D_{1,B}/D_{2,B} was calculated. The results are presented in Table 1. Note that numerical values presented in Table 1 were each an average value of five measured values at five respective points.

### [Short-Circuit Occurrence Rate]

In addition, an internal-short-circuit occurrence rate after the charging and discharging cycle was checked for the secondary battery 2 of each of Examples 1 to 17. A charging and discharging cycle test was conducted under the following test conditions.

### [Charging and Discharging Cycle Test Conditions]

(1) Environmental temperature at which the test was performed: 23° C.
(2) Charging condition: Constant current and constant voltage (CC-CV) charging was performed. The secondary battery 2 was charged with a constant current of 5 A until a voltage reached 4.2 V or 4.35 V, and was thereafter charged with a constant voltage of corresponding one of 4.2 V or 4.35 V. A cutoff current was set to 1 A.
(3) Rest time after charging: 60 minutes.
(4) Discharging conditions: Constant current (CC) discharging was performed with a constant current of 50 A. A cutoff voltage was set to 2.5 V, or discharging was stopped when a temperature reached 85° C.
(5): Where (2) to (4) were regarded as one cycle, the cycle was repeated until the capacity became 50% or less of the initial discharge capacity.

### [Short-Circuit Occurrence Rate After Charging and Discharging Cycle]

Each of the secondary batteries 2 was subjected to the charging and discharging cycle test under the above-described test conditions. Thereafter, each of the secondary batteries 2 was stored in an environment at 25° C.±5° C. for one week. After the storage, if a voltage drop of 4.1 V or more was observed, it was determined that a short circuit had occurred. The short-circuit occurrence rates for each of a case where the charging voltage was set to 4.2 V and a case where the charging voltage was set to 4.35 V are presented in Table 1.

TABLE 1

| | | | | Short-circuit occurrence rate | |
|---|---|---|---|---|---|
| | | | | after charging and discharging cycle | |
| | | | | [%] | |
| | | Area density ratio [%] | | 4.2 V | 4.35 V |
| | L1/L0 | D_{1, A}/D_{2, A} | D_{1, B}/D_{2, B} | charging | charging |
| Example 1 | 0.08 | 50 | 50 | 3 | 7 |
| Example 2 | 0.10 | 50 | 50 | 0 | 3 |
| Example 3 | 0.24 | 50 | 50 | 0 | 3 |
| Example 4 | 0.25 | 50 | 50 | 0 | 0 |
| Example 5 | 0.42 | 50 | 50 | 0 | 0 |
| Example 6 | 0.75 | 50 | 50 | 0 | 0 |
| Example 7 | 0.78 | 50 | 50 | 0 | 3 |
| Example 8 | 0.95 | 50 | 50 | 0 | 3 |
| Example 9 | 0.97 | 50 | 50 | 7 | 10 |
| Example 10 | 0.50 | 6 | 50 | 3 | 10 |
| Example 11 | 0.50 | 8 | 50 | 0 | 0 |
| Example 12 | 0.50 | 80 | 50 | 0 | 0 |
| Example 13 | 0.50 | 83 | 50 | 7 | 7 |
| Example 14 | 0.50 | 50 | 6 | 3 | 13 |
| Example 15 | 0.50 | 50 | 8 | 0 | 0 |
| Example 16 | 0.50 | 50 | 80 | 0 | 0 |
| Example 17 | 0.50 | 50 | 83 | 7 | 10 |
| Comparative | — | — | — | 20 | 27 |
| example 1 | | | | | |
| Comparative | 1.00 | 50 | 50 | 10 | 13 |
| example 2 | | | | | |

### Comparative Example 1

A secondary battery of Comparative example 1 was fabricated in a manner similar to that in Example 1 except that the thin part 61 was not provided, and was subjected to an evaluation similar to that in Example 1. The results are also presented in Table 1.

### Comparative Example 2

A secondary battery of Comparative example 2 was fabricated in a manner similar to that in Example 2 except that the ratio L1/L0 was set to 1, and was subjected to an evaluation similar to that in Example 1. The results are also presented in Table 1.

As indicated in Table 1, in each of Examples 1 to 17, it was possible to decrease the short-circuit occurrence rate after the charging and discharging cycle in both the case where the charging voltage was set to 4.2 V and the case where the charging voltage was set to 4.35 V, as compared with Comparative examples 1 and 2.

The results described above demonstrated that the secondary battery of the example embodiment of the present disclosure made it possible to achieve superior reliability. In particular, when each of the area density ratio D_{1,A}/D_{2,A} and the area density ratio D_{1,B}/D_{2,B} was greater than or equal to 8% and less than or equal to 80%, and the ratio L1/L0 was greater than or equal to 0.1 and less than or equal to 0.95, it was possible to decrease the short-circuit occurrence rate after the charging and discharging cycle with the charging voltage of 4.2 V to 0%, which demonstrated that it was possible to achieve even superior reliability.

Although the present disclosure has been described hereinabove with reference to some example embodiments and Examples, a configuration of any embodiment of the present disclosure is not limited to the configurations described in relation to the example embodiments and Examples, and is therefore modifiable in a variety of ways. For example, in the foregoing example embodiment, the description has been given of the example case where the electrode wound body has the outer appearance of the circular columnar shape in which the horizontal section is circular; however, an embodiment of the present disclosure is not limited to the above-described case. In some embodiments of the present disclosure, the electrode wound body may have, for example, an outer appearance of an elliptical columnar shape in which a horizontal section is elliptical.

For example, in the foregoing example embodiments and Examples, the description has been given of the case where the electrode reactant is lithium; however, the electrode reactant is not particularly limited. In some embodiments, the electrode reactant may be another alkali metal such as sodium or potassium, as described above. In some embodiments, the electrode reactant may be an alkaline earth metal such as beryllium, magnesium, or calcium, as described above. In some embodiments, the electrode reactant may be another light metal such as aluminum.

The effects described herein are mere examples, and effects of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described example embodiments of the present disclosure.

<1>

A secondary battery including:
an electrode wound body including a stacked body and having a through hole, the stacked body including a positive electrode, a negative electrode, and a separator and being wound along a longitudinal direction of the stacked body, the through hole extending through the electrode wound body in a width direction intersecting the longitudinal direction; and
an outer package can containing the electrode wound body, in which
the positive electrode includes
   a positive electrode current collector, and
   a positive electrode active material layer stacked on the positive electrode current collector and including a positive electrode active material,
the positive electrode active material layer includes a thin part and a thick part, the thick part having a thickness greater than a thickness of the thin part and being positioned on a winding outer periphery side of the electrode wound body relative to the thin part in the longitudinal direction, and
a position of a border between the thin part and the thick part is different, in a radial direction of the electrode wound body, from a position overlapping a position of a winding center side edge of the positive electrode, the winding center side edge being an edge of the positive electrode on a winding center side of the electrode wound body in the longitudinal direction.
   <2>

The secondary battery according to <1>, in which the positive electrode active material layer is stacked on one of two opposite surfaces of the positive electrode current collector, or is stacked on each of the two opposite surfaces of the positive electrode current collector.

<3>

The secondary battery according to <1> or <2>, in which the positive electrode active material layer has a single-layered structure or a multi-layered structure, the single-layered structure including a single film that includes the positive electrode active material, the multi-layered structure including multiple layers that are stacked and each include the positive electrode active material.

<4>

The secondary battery according to any one of <1> to <3>, in which the thin part is present only in an innermost positive electrode wind part that is a part, of the positive electrode included in the electrode wound body, corresponding to an innermost one wind of the positive electrode.

<5>

The secondary battery according to any one of <1> to <3>, in which Expression (1) below is satisfied,

$$0.1 \leq L 1 / L 0 \leq 0.95 \qquad ( 1 )$$

where
L0 is a length of an innermost positive electrode wind part in the electrode wound body, the innermost positive electrode wind part being a part, of the positive electrode included in the electrode wound body, corresponding to an innermost one wind of the positive electrode, and
L1 is a length, of the positive electrode, from a position of the winding center side edge of the positive electrode in the longitudinal direction to a position of the border between the thin part and the thick part in the longitudinal direction.
   <6>

The secondary battery according to any one of <1> to <5>, in which the thin part includes the winding center side edge of the positive electrode in the longitudinal direction.

<7>

The secondary battery according to any one of <1> to <6>, in which
the positive electrode current collector includes an inward positive electrode current collector surface and an outward positive electrode current collector surface, the inward positive electrode current collector surface facing toward a side of the through hole of the electrode wound body, the outward positive electrode current collector surface facing toward an opposite side to the through hole of the electrode wound body,
the positive electrode active material layer includes a first positive electrode active material layer and a second positive electrode active material layer, the first positive electrode active material layer being provided on the inward positive electrode current collector surface, the second positive electrode active material layer being provided on the outward positive electrode current collector surface, and
each of the first positive electrode active material layer and the second positive electrode active material layer includes the thin part and the thick part.
   <8>

The secondary battery according to <7>, in which a position of a border between the thin part and the thick part in the first positive electrode active material layer is different, in the radial direction of the electrode wound body, from a position of a border between the thin part and the thick part in the second positive electrode active material layer.

<9>

The secondary battery according to any one of <1> to <8>, in which the positive electrode active material layer further includes a grooved part between the thick part and the thin part.

<10>

A battery pack including:
the secondary battery according to any one of <1> to <9>;
a processor configured to control the secondary battery; and
an outer package body containing the secondary battery.

According to each of a secondary battery of at least one example embodiment of the present disclosure, and a battery pack including a secondary battery of at least one example embodiment of the present disclosure, a position of a border between a thin part and a thick part in each of one or more positive electrode active material layers is different, in a radial direction of an electrode wound body, from a position overlapping a position of a winding center side edge of a positive electrode. This reduces stress applied to a separator opposed to the winding center side edge of the positive electrode, caused by swelling of a negative electrode accompanying charging and discharging. Such reduction in stress applied to the separator helps to prevent the separator from being easily crushed. Accordingly, each of the secondary battery according to at least one example embodiment of the present disclosure and the battery pack according to at least one example embodiment of the present disclosure helps to achieve higher reliability.

Note that effects of an embodiment of the present disclosure are not necessarily limited to the example effects described above and may include any of a series of effects described herein in relation to the example embodiments of the present disclosure and the modification examples thereof.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a stacked body and having a through hole, the stacked body including a positive electrode, a negative electrode, and a separator and being wound along a longitudinal direction of the stacked body, the through hole extending through the electrode wound body in a width direction intersecting the longitudinal direction; and
an outer package can containing the electrode wound body, wherein
the positive electrode includes
a positive electrode current collector, and
a positive electrode active material layer stacked on the positive electrode current collector and including a positive electrode active material,
the positive electrode active material layer includes a thin part and a thick part, the thick part having a thickness greater than a thickness of the thin part and being positioned on a winding outer periphery side of the electrode wound body relative to the thin part in the longitudinal direction, and
a position of a border between the thin part and the thick part is different, in a radial direction of the electrode wound body, from a position overlapping a position of a winding center side edge of the positive electrode, the winding center side edge being an edge of the positive electrode on a winding center side of the electrode wound body in the longitudinal direction.

2. The secondary battery according to claim 1, wherein the positive electrode active material layer is stacked on one of two opposite surfaces of the positive electrode current collector.

3. The secondary battery according to claim 1, wherein the positive electrode active material layer is stacked on each of two opposite surfaces of the positive electrode current collector.

4. The secondary battery according to claim 1, wherein the positive electrode active material layer has a single-layered structure including a single film that includes the positive electrode active material.

5. The secondary battery according to claim 1, wherein the positive electrode active material layer has a multi-layered structure including multiple layers that are stacked and each include the positive electrode active material.

6. The secondary battery according to claim 1, wherein the thin part is present only in an innermost positive electrode wind part that is a part, of the positive electrode included in the electrode wound body, corresponding to an innermost one wind of the positive electrode.

7. The secondary battery according to claim 1, wherein Expression (1) below is satisfied,
$$0.1 \leq L 1 / L 0 \leq 0.95 \qquad ( 1 )$$
where
L0 is a length of an innermost positive electrode wind part in the electrode wound body, the innermost positive electrode wind part being a part, of the positive electrode included in the electrode wound body, corresponding to an innermost one wind of the positive electrode, and
L1 is a length, of the positive electrode, from a position of the winding center side edge of the positive electrode in the longitudinal direction to a position of the border between the thin part and the thick part in the longitudinal direction.

8. The secondary battery according to claim 1, wherein the thin part includes the winding center side edge of the positive electrode in the longitudinal direction.

9. The secondary battery according to claim 1, wherein
the positive electrode current collector includes an inward positive electrode current collector surface and an outward positive electrode current collector surface, the inward positive electrode current collector surface facing toward a side of the through hole of the electrode wound body, the outward positive electrode current collector surface facing toward an opposite side to the through hole of the electrode wound body,
the positive electrode active material layer includes a first positive electrode active material layer and a second positive electrode active material layer, the first positive electrode active material layer being provided on the inward positive electrode current collector surface, the second positive electrode active material layer being provided on the outward positive electrode current collector surface, and
each of the first positive electrode active material layer and the second positive electrode active material layer includes the thin part and the thick part.

10. The secondary battery according to claim 9, wherein a position of a border between the thin part and the thick part in the first positive electrode active material layer is different, in the radial direction of the electrode wound body, from a position of a border between the thin part and the thick part in the second positive electrode active material layer.

11. The secondary battery according to claim 1, wherein the positive electrode active material layer further includes a grooved part between the thick part and the thin part.

12. A battery pack comprising:
a secondary battery;
a processor configured to control the secondary battery; and
an outer package body containing the secondary battery,
the secondary battery including
an electrode wound body including a stacked body and having a through hole, the stacked body including a positive electrode, a negative electrode, and a separator and being wound along a longitudinal direction of the stacked body, the through hole extending through the electrode wound body in a width direction intersecting the longitudinal direction, and
an outer package can containing the electrode wound body, wherein
the positive electrode includes
a positive electrode current collector, and
a positive electrode active material layer stacked on the positive electrode current collector and including a positive electrode active material,
the positive electrode active material layer includes a thin part and a thick part, the thick part having a thickness greater than a thickness of the thin part and being positioned on a winding outer periphery side of the electrode wound body relative to the thin part in the longitudinal direction, and
a position of a border between the thin part and the thick part is different, in a radial direction of the electrode wound body, from a position overlapping a position of a winding center side edge of the positive electrode, the winding center side edge being an edge of the positive electrode on a winding center side of the electrode wound body in the longitudinal direction.
